(19) United States
(12) Patent Application Publication
(10) Pub. No.: US 2007/0243618 A1
(43) Pub. Date: Oct. 18, 2007

(54) Device and method for non-invasive oxygen sensing of sealed packages

(75) Inventors: David Wayne Hatchett, Las Vegas, NV (US); Byron Lee Bennett, Las Vegas, NV (US); Devinder Pal Singh Saini, Las Vegas, NV (US)

Correspondence Address: CHALKER FLORES, LLP, 2711 LBJ FRWY, Suite 1036, DALLAS, TX, 75234, US

(73) Assignee: OxySense, Inc., Dallas, TX (US)

(21) Appl. No.: 11/402,422

(22) Filed: Apr. 11, 2006

(51) Int. Cl. G01N 31/00

(52) U.S. Cl. 436/1; 436/166; 436/172

(57) ABSTRACT

The present invention provides a system, method and composition for detecting exposure of the contents of a container to one or more gases using a gas sensitive package sensor. The gas sensitive package sensor includes a ruthenium-based luminescence indicator composition having a ruthenium-based luminescence compound having one or more optical properties dispersed within a gas permeable polymer matrix. Exposure to one or more gases modifies the one or more optical properties of the ruthenium-based luminescence compound.

### TECHNICAL FIELD OF THE INVENTION

The present invention relates in general to sensing or determining the presence or concentration of an analyte in a medium, and more particularly, to determining the presence or concentration of a gaseous component, e.g., oxygen, in an enclosure containing food or any other oxygen sensitive material for providing quality control and determining package tampering.

### BACKGROUND OF THE INVENTION

Oxygen ingress into sealed food packages causes many issues within the food industry. One problem that faces the food industry is oxidation of foods during storage. Although most of the packages have some form of oxygen barriers, oxygen can still permeate into the package through micro-pores, holes, inconsistent sealing and other defects. The oxygen can not only oxidize the contents but can affect the flavor of the product causing spoilage and leading to a reduction in shelf life. Generally, the oxygen permeation is controlled through package design and the use of oxygen barriers and active packaging.

For example, a large portion of food is packaged with a modified atmosphere in an effort to keep products fresh. The basic features of this process are hermetic seals, high barrier film and gas injection to reduce the oxygen content inside the packs. During the distribution, the modified atmosphere can undergo composition changes for various reasons, e.g., reactions with the product, permeability of materials and defective sealing are but a few. Although the modified atmosphere limits the initial oxygen concentration, the oxygen concentration will increase over time.

Therefore, it is important to monitor the oxygen concentration in packages to determine the freshness of the content. Ideally, this should be done on the production line allowing oxygen measurements to be made in-line and prior to shipment of packages to ensure product quality to consumers and retailers and ultimately at the supermarket checkout.

Most of the traditional techniques for measuring of oxygen within a package are invasive and result in damage to the package itself. Generally, the determination of the internal concentration of oxygen in a closed package or food container requires that the package by pierced by the oxygen probe. The head-space above the product in the package is monitored for oxygen concentration using an oxygen sensor. Possible sensors include amperometric and optical probes that are sensitive to oxygen concentration. The disadvantage of this method is based on the requirement that the oxygen probes pierce the packages or containers. Once the package is pierced oxygen is free to diffuse into the packaging resulting in higher concentrations within the container. Therefore care must be taken to ensure consistency in the methodology used to pierce the packages or containers to obtain reproducible results. The package must then be discarded after the measurement is made. Although this type of testing is very sensitive to oxygen content within the package, only a few packages can be tested. Given the invasive nature of the traditional oxygen measurement technology, one hundred percent testing of packages is not possible due to its destructive nature. This leads to statistical concentrations calculation and ultimately guessing at the content of any specific container. Traditional technologies make it difficult to identify leaks let alone implement optimization of the packaging process to reduce the number of leaking packages.

Similarly, using the traditional methods, there is no way for determining if tampering has occurred prior to the exposure of the package to the atmosphere. Finally, in many cases the response of the sensor is not sufficiently fast to ensure the concentration of oxygen measured is consistent with the sealed container or package prior to piercing. The equilibrium between the probe and oxygen must be rapid to ensure that the lowest relative oxygen concentration is measured relative to the actual head-space concentration of oxygen prior to piercing the package or container.

U.S. Pat. No. 5,407,829 (“the '829 patent”) entitled, “Method for quality control of packaged organic substances and packaging material for use with this method,” issued to Wolfbeis, et al., teaches quality control of packaged organic substances, preferably packaged foods and drugs. The materials to be examined are brought into contact with a planar optical sensor element which is applied on the inside of the wrapping and responds to a change in the gas composition in the gas space above the sample by a change in color or fluorescence. The change of one of the optical properties of the sensor element is detected visually or opto-electronically.

The '829 patent teaches gaseous species in a closed container using sensors based on a Silicon (Si) polymers permeable to gaseous species such as H₂S, CO₂, mercaptan, ammonia, or amine with corresponding decreases in O₂. The sensor consists of a concentration. A planar optical sensor is applied to the inside of the package, which responds to changes in the head-space above the sample by a change in color or fluorescence. In the simplest form the properties of the sensor are probed externally through the sealed package or container visually through changes in color of an indicator. A more complex form involves the use of fluorescent excitation to monitor changes in the fluorescence intensity. The polymer contains the indicator substance dispersed as droplets of either an aqueous or organic emulsion. These methods are strictly qualitative and used to determine if decomposition of the product has occurred over time with the release of gases associated with bacterial reaction. However, with this method it is difficult to determine the exact concentration of each gaseous species and the overall content of oxygen as the bacterial reactions occur.

U.S. Pat. No. 4,657,736 (“the '736 patent”) entitled, “Sensor element for determining the oxygen content and a method of preparing the same,” issued to Marsoner, et al., teaches an O₂ sensor element which contains a fluorescent indicator substance and a polymerized silicone polymer used as a carrier material in which the indicator substance is incorporated in solubilized form and in an at least approximately homogeneous distribution. Solubilization of the indicator substance may essentially be performed in analogy to Friedel-Crafts alkylation of aromatics, which will increase solubility of the indicator substance in the polymer carrier without affecting quenching behavior. The sensor is designed to detect oxygen through fluorescence quenching that can be obtained by the use of a cured silicon polymer matrix to which an indicator substance is added and homogeneously dispersed into the polymer in soluble form. However, most polymers are not sufficiently permeable to oxygen, the solubility of the dye is increased such that the quenching of the incorporated chromophores by O₂ can be observed by changes in the intensity of the fluorescence. The method implies that without these modifications, the detection of oxygen using oxygen sensitive dyes is impossible due to dye aggregation, heterogeneous distribution of the dye and low solubility of the dye in the polymer. Furthermore, the polymer matrix material is limited to Si based polymers, which are inherently miscible with the dye molecules.

Other combinations of polymer and dye have shown issues of stability and decomposition. For example, the photo stability of polymer/dye oxygen sensor systems have been examined, e.g., U.S. Pat. Nos. 4,775,514; 4,810,655; 5,043,286; 5,030,420; 5,070,158; 5,128,103; and 5,511,547. In each case the stability of the dye within the polymer matrix was examined with respect to singlet oxygen and statement regarding the stability of the systems was made. The polymer systems in general are prone to photo-decomposition, which is triggered by the irradiation of the sample by the source light. Similarly, the dye itself can be sensitive to photo-bleaching resulting in a loss of fluorescent signal over time requiring the re-calibration of the sensor. The solution to these photo induced processes (e.g., U.S. Pat. No. 6,254,829) includes the incorporation of a species specifically designed to deactivate singlet oxygen so that stability is enhanced within the system.

For example, U.S. Pat. No. 4,657,736, entitled, “Sensor element for determining the oxygen content and a method of preparing the same,” issued to Marsoner, et al. teaches an O₂ sensor element which contains a fluorescent indicator substance and a polymerized silicone polymer was used as a carrier material in which the indicator substance is incorporated in solubilized form and in an at least approximately homogeneous distribution. The patent teaches that solubilization of the indicator substance may essentially be performed in analogy to Friedel-Crafts alkylation of aromatics, which will increase solubility of the indicator substance in the polymer carrier without affecting quenching behavior.

U.S. Pat. No. 5,552,272 issued to Bogart teaches a device for detecting the presence or amount of an analyte of interest, comprising a reflective solid, optical support and a label capable of generating fluorescent signal upon excitation with a suitable light source wherein the support includes an attachment layer having a chemical selected from the group consisting of dendrimers, star polymers, molecular self-assembling polymers, polymeric siloxanes and film forming latexes wherein the support provides an enhanced level of exciting photons to the immobilized fluorescent label compound, and wherein the support also increases the capture of fluorescent signal.

The foregoing problems have been recognized for many years and while numerous solutions have been proposed, none of them adequately address all of the problems.

### SUMMARY OF THE INVENTION

The present inventors recognized a need for a method, system, device and sensing materials for the detection of oxygen within a sealed container to allow quality control and assurance of packaged materials that includes food or any other oxygen sensitive material. In addition, the inventors also recognized a need for a system, device and sensing material to provide for determining package tampering.

The present inventors recognized that a method, system, device and sensing material for detecting oxygen content through a barrier is useful for quality control in day-to-day operations. The method should be relatively quick and be both qualitative and quantitative. It should also be activated on demand and capable of detecting manufacturing defects or tampering, e.g., pinholes.

Generally, the present invention includes a ruthenium-based luminescence indicator composition having a ruthenium-based luminescence compound having one or more optical properties dispersed within a gas permeable polymer matrix. Exposure to one or more diffusible agents modifies the one or more optical properties of the ruthenium-based luminescence compound.

The present invention provides a ruthenium-based luminescence indicator composition that includes a tris-4,7-diphenyl-1,10-phenanthroline ruthenium(II) compound and one or more dioctylphthalate dispersed within a gas permeable polyacrylate matrix. The tris-4,7-diphenyl-1,10-phenanthroline ruthenium(II) compound has a fluorescence lifetime that is affected by exposure to one or more gases and exposure to the one or more gases is monitored.

The present invention also provides a food packaging membrane for detecting one or more analytes within a package. The food packaging membrane includes a diffusible polymer matrix membrane having a ruthenium-based luminescence compound dispersed within a diffusible polymer matrix. The ruthenium-based luminescence compound has one or more optical properties and interacts with one or more analytes that modify the optical property of the ruthenium-based luminescence compound to provide information on the one or more analytes.

In addition, the present invention provides an optical sensor system. The system includes an indicator capable of emitting an optical signal and a transceiver positioned to detect one or more signals from the luminescence ruthenium compound. The indicator includes a luminescence ruthenium compound dispersed within a gas permeable polymer matrix, wherein exposure to one or more diffusible agents modifies the optical signal of the ruthenium-based luminescence compound.

The present invention also includes a package monitoring system. The system includes a sealable package in communication with a ruthenium-based luminescence sensor comprising a luminescence ruthenium compound having one or more analyte modifiable optical properties dispersed within a gas permeable polymer matrix. Exposure to one or more analytes affects the one or more analyte modifiable optical properties of the ruthenium-based luminescence compound. A package transceiver module is positioned to detect one or more signals from the luminescence ruthenium compound. A tag is positioned on, in or about the sealable package, wherein the tag encodes one or more packets of information.

The present invention includes a method of detecting exposure to one or more gases within a container by detecting one or more optical properties of a luminescent ruthenium compound that is dispersed in a gas permeable polymeric material. The luminescent ruthenium compound has one or more optical properties that are modified by exposure to one or more gases. The one or more optical properties of the luminescent ruthenium compound are then correlated to exposure to one or more gases.

The present invention also provides a method of detecting exposure of a ruthenium-based optical sensor to one or more gases by generating an emission signal from a ruthenium-based optical sensor. The ruthenium-based optical sensor includes a luminescent ruthenium-based compound dispersed within a polymer matrix and disposed within an enclosure, wherein the emission signal is affected by the exposure of the luminescent ruthenium-based compound to one or more gases. The emission signal is detected and correlated to a gases concentration of the one or more gases. The concentration of the one or more gases can then be displayed.

The present invention includes a method of making a gas sensitive package sensor for detecting exposure to one or more gases by forming a ruthenium-based package sensor having a ruthenium-based luminescence compound dispersed in a gas permeable polymeric substrate and affixing the ruthenium-based sensor in, on or about a package, wherein the ruthenium-based luminescence compound is in fluid communication with an interior surface of the package and the contents of the package.

### BRIEF DESCRIPTION OF THE DRAWINGS

For a more complete understanding of the features and advantages of the present invention, reference is now made to the detailed description of the invention along with the accompanying figures and in which:

FIG. 1 is a graph of the time constant verses the luminescence indicator/polymer ratio;

FIG. 2 is a graph of the time constant verses the plasticizer content in the polymeric system;

FIG. 3 is a graph of the percent polymer in solution as a function of application method;

FIG. 4 is a graph of the post cure response of sensor material as a function of preparation method;

FIG. 5 is a schematic of the oxygen measurement using fluorescence decay;

FIG. 6 is a general schematic of the oxygen sensitive reading device of the present invention;

FIG. 7 is a schematic that illustrates one embodiment of the oxygen sensitive luminescence indicator reading device of the present invention;

FIGS. 8A and 8B illustrates ruthenium(II) complexes;

FIG. 9 illustrates the structure of a Nafion monomer;

FIGS. 10A and 10B illustrate the structure of polystyrene and poly(sodium-4-styrene)sulfonate anionic polymers;

FIG. 11 is a graph of a theoretical Stern-Volmer plot for Ru(Ph₂Phen)₃²⁺;

FIG. 12 illustrates a non-linear Stern-Volmer plot for Ru(Ph₂Phen)₃²⁺;

FIG. 13 is a graph of the relative fluorescence signals measured at different oxygen partial pressures;

FIG. 14 is a schematic that illustrates the preparation of cis-bis(4,7-diphenyl-1,10-phenanthroline)ruthenium(II)dichloride;

FIGS. 15 and 16 are schematics that illustrate the preparation of tris(4,7-diphenyl-1,10-phenanthroline)ruthenium(II)hexafluorophosphate complex;

FIG. 17 is a schematic that illustrates one embodiment of the present invention;

FIG. 18 is a graph that shows the fluorescence lifetime signal in ambient air as appeared on the main screen of the device of the present invention;

FIG. 19 is a schematic diagram of measuring the oxygen content in sealed package using the present invention;

FIG. 20 is a graph of the lifetimes of a nafion polymer sample;

FIG. 21 is a graph of the plasticizer incorporated into the ruthenium-polystyrene mixture dissolved in ethyl acetate;

FIG. 22 is a graph that illustrates the ΔT_{C} data for changing ruthenium concentration in polystyrene;

FIG. 23 is a graph of the fluorescence lifetime for polystyrene-ruthenium system with various plasticizer concentrations;

FIG. 24 is a graph of ΔT_{C} values obtained for the polystyrene polymer concentration and polystyrene dissolved in ethyl acetate;

FIG. 25 is a graph that illustrates the polymer, plasticizer and ruthenium concentrations;

FIG. 26 is a graph of the optimization of the plasticizer carried out using two different concentrations of ruthenium complex;

FIG. 27 is a graph that shows the T_{C} and ΔT_{C} data for changing plasticizer concentration in polyacrylate;

FIG. 28 is a graph of the ΔT_{C} values with varying plasticizer concentration;

FIG. 29 is a graph that shows the ΔT_{C} data for changing ruthenium concentration;

FIG. 30 is a graph of that shows the ΔT_{C} data for changing ruthenium concentration;

FIG. 31 is a graph of polymer concentrations;

FIG. 32 is a graph of ΔT_{C} values for the polymer concentration of polyacrylate dissolved in dichloromethane drop series;

FIGS. 33 and 34 are graphs that show T_{C} and ΔT_{C} values obtained for various polymer concentrations;

FIGS. 35 and 36 are graphs that illustrate the T_{C} and ΔT_{C} values for polyacrylate polymer;

FIG. 37 is a graph that shows the T_{C} values obtained for polymer concentration of polyacrylate dissolved in ethyl acetate; and

FIG. 38 is a graph that illustrates the T_{C} and ΔT_{C} values obtained for the reconstituted materials.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The terminology used and specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, the term “ruthenium-based luminescence indicator,” “sensor ticket,” “luminescence indicator” are used interchangeably to denote a indicator or sensor having a luminescence indicator dispersed about a polymer matrix.

As used herein, the term “optically transparent” refers to the transmission of an optical signal at a minimum of the excitation wavelengths and the emission wavelengths used with the present invention.

As used herein, the term “oxygen sensitive chromophore,” “chromophore,” “dye,”“ruthenium-based luminescence compound,” “luminescence compound,” “ruthenium-based compound,” “ruthenium compound,” “oxygen sensitive ruthenium-based luminescence compound,” “oxygen sensitive ruthenium compound,” “oxygen sensitive luminescence compound,” are used herein interchangeably.

As used herein, the term “alkyl” denotes branched or unbranched hydrocarbon chains, preferably having about 1 to about 8 carbons, such as, methyl, ethyl, n-propyl, iso-propyl, n-butyl, sec-butyl, iso-butyl, tert-butyl, octa-decyl and 2-methylpentyl. These groups can be optionally substituted with one or more functional groups which are attached commonly to such chains, such as, hydroxyl, bromo, fluoro, chloro, iodo, mercapto or thio, cyano, alkylthio, heterocyclyl, aryl, heteroaryl, carboxyl, carbalkoyl, alkyl, alkenyl, nitro, amino, alkoxyl, amido, and the like to form alkyl groups such as trifluoro methyl, 3-hydroxyhexyl, 2-carboxypropyl, 2-fluoroethyl, carboxymethyl, cyanobutyl and the like.

As used herein, the term “alkylene” refers to a divalent alkyl group as defined above, such as methylene (—CH₂—), propylene (—CH₂CH₂CH₂—), chloroethylene (—CHClCH₂—), 2-thiobutene —CH₂CH(SH)CH₂CH₂, 1-bromo-3-hydroxyl-4-methylpentene (—CHBrCH₂CH(OH)CH(CH₃)CH₂—), and the like.

As used herein, the term “alkenyl” denotes branched or unbranched hydrocarbon chains containing one or more carbon-carbon double bonds.

As used herein, the term “alkynyl” refers to branched or unbranched hydrocarbon chains containing one or more carbon-carbon triple bonds.

As used herein, the term “aryl” denotes a chain of carbon atoms which form at least one aromatic ring having between about 4-14 carbon atoms, such as phenyl, naphthyl, and the like, and which may be substituted with one or more functional groups which are attached commonly to such chains, such as hydroxyl, bromo, fluoro, chloro, iodo, mercapto or thio, cyano, cyanoamido, alkylthio, heterocycle, aryl, heteroaryl, carboxyl, carbalkoyl, alkyl, alkenyl, nitro, amino, alkoxyl, amido, and the like to form aryl groups such as biphenyl, iodobiphenyl, methoxybiphenyl, anthryl, bromophenyl, iodophenyl, chlorophenyl, hydroxyphenyl, methoxyphenyl, formylphenyl, acetylphenyl, trifluoromethylthiophenyl, trifluoromethoxyphenyl, alkylthiophenyl, trialkylammoniumphenyl, amidophenyl, thiazolylphenyl, oxazolylphenyl, imidazolylphenyl, imidazolylmethylphenyl, and the like.

As used herein, the term “alkoxy” denotes —OR—, wherein R is alkyl. The term “alkylcarbonyl” denote an alkyl group as defined above substituted with a C(O) group, for example, CH₃C(O)—, CH₃CH₂C(O)—, etc. As used herein, the term “alkylcarboxyl” denote an alkyl group as defined above substituted with a C(O)O group, for example, CH₃C(O)O—, CH₃CH₂C(O)O—, etc.

As used herein, the term “amido” denotes an amide linkage: —C(O)NHR (wherein R is hydrogen or alkyl). The term “amino” denotes an amine linkage: —NR—, wherein R is hydrogen or alkyl.

As used herein, the term “carboxyl” denotes —C(O)O—, and the term “carbonyl” denotes —C(O)—. The term “cycloalkyl” signifies a saturated, cyclic hydrocarbon group with 3-8, preferably 3-6 carbon atoms, i.e. cyclopropyl, cyclobutyl, cyclopentyl and cyclohexyl and the like.

As used herein, the term “lower alkyl” refers to branched or straight chain alkyl groups comprising one to ten carbon atoms, including methyl, ethyl, propyl, isopropyl, n-butyl, t-butyl, neopentyl and the like.

As used herein, the term “alkoxy” refers to RO, wherein R is a lower alkyl group as defined herein. “Alkoxy groups” include, for example, methoxy, ethoxy, t-butoxy and the like. The term “alkoxyalkyl” as used herein refers to an alkoxy group as previously defined appended to an alkyl group as previously defined. Examples of alkoxyalkyl include, but are not limited to, methoxymethyl, methoxyethyl, isopropoxymethyl and the like.

As used herein, the term “hydroxy” refers to —OH. The term “hydroxyalkyl” as used herein refers to a hydroxy group as previously defined appended to a lower alkyl group as previously defined. The term “alkenyl” as used herein refers to a branched or straight chain C₂-C₁₀ hydrocarbon which also comprises one or more carbon-carbon double bonds.

As used herein, the term “amino” refers to —NH₂. The term “nitrate” as used herein refers to —O—NO₂. The term “alkylamino” as used herein refers to RNH— wherein R is as defined in the specification. Alkylamino groups include, for example, methylamino, ethylamino, butylamino, and the like. The term “dialkylamino” as used herein refers to RRN— wherein R is independently selected from lower alkyl groups as defined herein. Dialkylamino groups include, for example dimethylamino, diethylamino, methyl propylamino and the like.

As used herein, the term “nitro” refers to the group —NO₂ and “nitrosated” refers to compounds that have been substituted therewith. The term “nitroso” as used herein refers to the group —NO and “nitrosylated” refers to compounds that have been substituted therewith.

As used herein, the term “aryl” refers to a mono- or bi-cyclic carbocyclic ring system having one or two aromatic rings including, but not limited to, phenyl, naphthyl, tetrahydronaphthyl, indanyl, indenyl, and the like. Aryl groups (including bicyclic aryl groups) can be unsubstituted or substituted with one, two or three substitutents independently selected from lower alkyl, haloalkyl, alkoxy, amino, alkylamino, dialkylamino, hydroxy, halo, and nitro. In addition, substituted aryl groups include tetrafluorophenyl and pentafluorophenyl.

As used herein, the term “alkylaryl” refers to a lower alkyl radical to which is appended an aryl group. Arylalkyl groups include, for example, benzyl, phenylethyl, hydroxybenzyl, fluorobenzyl, fluorophenylethyl and the like.

As used herein, the term “arylalkoxy” refers to an alkoxy radical to which is appended an aryl group. Arylalkoxy groups include, for example, benzyloxy, phenylethoxy, chlorophenylethoxy and the like.

As used herein, the term “cycloalkyl” refers to an alicyclic group comprising from about 3 to about 7 carbon atoms including, but not limited to, cyclopropyl, cyclobutyl, cyclopentyl, cyclohexyl and the like. The term “cycloalkoxy” as used herein refers to RO— wherein R is cycloalkyl as defined in this specification. Representative examples of alkoxy groups include cyclopropoxy, cyclopentyloxy, and cyclohexyloxy and the like.

As used herein, the term “arylthio” refers to RS— wherein R is an aryl group as defined herein. The term “alkylsulfinyl” as used herein refers to R—S(O)2- wherein R is as defined in this specification.

As used herein, the term “caboxamido” herein refers to —C(O)NH2. The term “carbamoyl” as used herein refers to —O—C(O)NH2. The term “carboxyl” as used herein refers to —CO2H. The term “carbonyl” as used herein refers to —C(O)—.

As used herein, the term “halogen” or “halo” refers to I, Br, Cl, or F. The term “haloalkyl” as used herein refers to a lower alkyl radical to which is appended one or more halogens. Representative examples of haloalkyl group include trigluoromethyl, chloromethyl, 2-bromobutyl, 1-bromo-2-chloro-pentyl and the like.

As used herein, the term “haloalkoxy” refers to a haloalkyl radical as defined herein to which is appended an alkoxy group as defined herein. Representative examples of haloalkoxy groups include 1,1,1-trichloroethoxy, 2-bromobutoxy and the like. The term “heteroaryl” as used herein refers to a mono- or bi-cyclic ring system containing one or two aromatic rings and containing at least one nitrogen, oxygen, or sulfur atom in an aromatic ring. Heteroaryl groups (including bicyclic heteroaryl groups) can be unsubstituted or substituted with one, two or three substitutents independently selected from lower alkyl, haloalkyl, alkoxy, amino, alkylamino, dialkylamino, hydroxy, halo and nitro. Examples of heteroaryl groups include, but are not limited to, pyridine pyrazine, pyrimidine, pyridazine, pyrazole, triazole, thiazole, isothiazole, benzothiazole, benzoxazole, thiadiazole, oxazole, pyrrole, imidazole, isoxazole and the like.

As used herein, the term “heterocyclic ring” refers to any 3-, 4-, 5-, 6-, or 7-membered nonaromatic ring containing at least one nitrogen atom, oxygen atom, or sulfur atom which is bonded to an atom which is not part of the heterocyclic ring. The term “arylheterocyclic ring” as used herein refers to a bi- or tri-cyclic ring comprised of an aryl ring as previously defined appended via two adjacent carbon atoms of the aryl group to a heterocyclic ring as previously defined. The term “heterocyclic compounds” as used herein refers to mono- and poly-cyclic compounds containing at least one heteroaryl or heterocyclic ring, as defined herein.

As used herein, the term “amido” refers to —NH—C(O)—R wherein R is a lower alkyl, aryl, or heretoaryl group, as defined herein. The term “alkylamido” as used herein refers to R1N—C(O)—R2 wherein R1 is a lower alkyl group as defined herein and R2 is a lower alkyl, aryl, or heretoaryl group, as defined herein.

As used herein, the term “carboxylic ester” refers to —C(O)OR, wherein R is a lower alkyl group as defined herein. The term “carboxylic acid” as used herein refers to —C(O)OH.

The present invention provides a method, system, device and apparatus for measuring changes in oxygen concentration in closed packages or containers. The present invention can also be used to determine if a sealed container with a known atmosphere has been pierced, damaged, contaminated or tampered with. In addition, normal oxygen permeation or faults in container packaging can be detected prior to release of product to the consumer.

In one embodiment of the present invention, an oxygen sensitive chromophore having fluorescent properties is dispersed in a polymer matrix affixed to the inside of the closed container to monitor the oxygen concentration within the container or package. The present invention also includes a chromophore dispersed in a polymer matrix to form an affixable sensor ticket that can be positioned on the inside of the packaging. This allows the head-space gases to contact the sensor ticket. Changes in the oxygen concentration result in the interaction of the oxygen and the chromophore to produce detectable changes in the fluorescent lifetime of the chromophore. In one embodiment, an optical detector is used to monitor the fluorescent lifetime of the chromophore through an optically transparent area of the package.

One method provided by the present invention includes an external reading device that probes the optical properties of the sensor ticket without perforation of the packaging. For example, a breech in the package will change the internal concentration of oxygen within the package; as a result, the sensor ticket interacts with the oxygen to change the optical properties of the sensing ticket. In some embodiments, the external reading device includes a probe, internally positioned or externally positioned, that serves as the excitation source and the emission detector.

Generally, the ruthenium-based luminescence indicator includes a thin layer of sensor material, which can be contacted with the package material either with or without an oxygen permeable food contact layer or cover. The sensor element is constructed to respond to changes in oxygen content that can be monitored as a function of time. The sensor element is constructed with a hydrophobic polymer such that it is selective to gaseous species and impermeable to liquid common in packaged food.

In one embodiment of the present invention, the luminescence indicator is affixed to the packaging using common adhesives to the food industry such that the adhesive is optically transparent and provides no change in either the source light or detection of optical properties.

The present invention includes a method of detecting exposure of a ruthenium-based optical sensor to one or more gases by generating an emission signal, detecting the emission signal and correlating it to a gases concentration of the one or more gases so that it can displayed or recorded. The emission signal is generated from a ruthenium-based optical sensor having a luminescent ruthenium-based compound dispersed within a polymer matrix and disposed within an enclosure. The emission signal is affected by the exposure of the luminescent ruthenium-based compound to one or more gases. By correlating the emission signal to gas level within the container, a concentration of the one or more gases can be displayed or stored.

A method of making a gas sensitive package sensor for detecting exposure to one or more gases is provided by the present invention. A ruthenium-based package sensor is formed having a ruthenium-based luminescence compound dispersed in a gas permeable polymeric substrate. The ruthenium-based sensor is affixed in, on or about a package. The ruthenium-based luminescence compound is in fluid communication with an interior surface of the package and the contents of the package.

The present invention includes a ruthenium-based luminescence indicator. The ruthenium-based luminescence indicator includes a ruthenium-based luminescence compound having one or more optical properties dispersed within a gas permeable polymer matrix. Exposure to one or more diffusible agents modifies the one or more optical properties of the ruthenium-based luminescence compound.

The present invention provides a ruthenium-based luminescence indicator composition that includes a tris-4,7-diphenyl-1,10-phenanthroline ruthenium(II) compound and one or more dioctylphthalate dispersed within a gas permeable polyacrylate matrix. The tris-4,7-diphenyl-1,10-phenanthroline ruthenium(II) compound has a fluorescence lifetime that is affected by exposure to one or more gases and exposure to the one or more gases is monitored.

Although plasticizers may be used with the present invention, the gas permeable polymer matrix is substantially free of leachable plasticizers. Plasticizers that leach into the container may affect the taste, composition, physical properties, chemical properties or other properties. Typical plasticizers known to the skilled artisan may be used, for example, dioctyl phthalate, diphenyl isophthalate, p-toluene sulfonic acid monohydrate, phthalic acid benzyl n-butyl ester, diphenyl phthalate, p-styrene sulfonic acid, allylsulfonic acid sodium salt, vinylsulfonic acid sodium salt and combinations thereof.

The ruthenium-based luminescence compound includes one or more ruthenium(II)polypyridyl complexes. Specific examples include tris-4,7-diphenyl-1,10-phenanthroline ruthenium(II) or tris-2,2′-bipyridyl ruthenium(II). The ruthenium-based luminescence compound may also include pyrene-butyric acid, perylene-dibutyrate, benzo-perylene, vinylbenzo-perylene, (4,7-diphenyl-1,1-phenanthroline)3Ru(II), and ligand metal complexes of ruthenium(II), osmium(II), iridium(III), rhodium(III) and chromium(III) ions with 2,2′-bipyridine, 1,10-phenanthroline, 4,7-diphenyl-(1,20-phenanthroline), 4,7-dimethyl-1,10-phenanthroline, 4,7-disulfonated-diphenyl-1,10-phenanthroline, 5-bromo-1,10-phenanthroline, 5-chloro-1,10-phenanthroline, 2-2′bi-2-thiazoline, 2,2′-bithiazole, or other a-diimine ligands and tetrabenzo-Pt-porphyrin, tetraphenyl-Pt-porphyrin, octaethyl-Pt-porphyrin, octaethyl-Pt-porphyrin ketone, octaethyl-Pt-chlorin, tetraphenyl-Pt-chlorin and other porphyrin derivatives. In addition the metal may include molybdenum, tungsten, zirconium, titanium, ruthenium, or mixtures thereof.

The luminescent compound is contained within a selectively gas permeable polymer matrix that is permeable to gases (e.g., oxygen) and relatively impermeable to water and non-gaseous analytes. The one or more diffusible agents that may be allowed to diffuse into the polymer include gases, liquids, particles, solids or combinations thereof depending on the polymer constitutes. In some embodiments the gas permeable polymer matrix is at least partially light-transmissive. Specific examples of the gas permeable polymer matrix of the present invention include polystyrene, protonated polystyrene, polyacrylate, nafion or combinations thereof. the skilled artisan will recognize that other polymers may be used, e.g., polystyrene, polyvinylchloride, plasticized polyvinylchloride, polymethylmethacrylate, plasticized polymethylmethacrylate, a polymethylmethacrylate/cellulose-acetyl-butyral mixture, a silicone, poly-α-methylstyrene, a polysulfone, polytetrafluoroethylene, a polyester, polybutadiene, polystyrene-co-butadiene, polyurethane, polyvinylbutyral, polyethylacrylate and poly-2-hydroxyethylmethacrylate.

The present invention also includes a polymers matrix having one or more polystyrenes, polyalkanes, polymethacrylates, polynitriles, polyvinyls, polydienes, polyesters, polycarbonates, polysiloxanes, polyamides, polyacetates, polyimides, polyurethanes, celluloses and derivatives thereof.

The gas permeable polymer matrix may include one or more poly(amides), poly(acrylamides), poly(styrenes), poly(acrylates), poly(alkylacrylates), poly(nitriles), poly(vinyl chlorides), poly(vinyl alcohols), poly(dienes), poly(esters), poly(carbonates), poly(siloxanes), poly(urethanes), poly(olefins), poly(imides), and cellulosics.

Additionally, the present invention may include a gas permeable polymer matrix coated with a second polymer to prevent contamination. The second polymer may be of the same composition and properties or of different composition and properties depending on the specific needs and applications.

The gas permeable polymer matrix or second polymer may include an ionomer resin, an acrylonitrile-acrylic-styrene resin, an acrylonitrile-styrene resin, an acrylonitrile-butadienestyrene resin, a methylmethacrylate-butadiene-styrene resin, a phenoxy resin, an ethylene-vinylchloride copolymer, an ethylene-vinylacetate copolymer, a polystyrene, a polyvinylidene chloride, a vinyl acetate, a polyethylene, a polypropylene, a polybutadiene, a polyvinylidene fluoride, a polytetrafluoroethylene, a polyacetal, a polyamide, a polyamide-imide, a polyarylate, a polyether-imide, a polyether-ether ketone, a polyethyleneterephthalate, a polybutyleneterephthalate, a polycarbonate, a polysulphone, a polyethersulphone, a polyphenylene oxide, a polyphenylene sulfide, a polymethylmethacrylate, a guanamine resin, a diallylphthalate resin, a vinyl ester resin, a phenol resin, an unsaturated polyester resin, a furan resin, a polyimide resin, a poly-p-hydroxybenzoate, a styrene-butadiene rubber, a polybutadiene rubber, a polyisoprene rubber, an acrylonitrile-butadiene rubber, a polychloroprene rubber, a butyl rubber, a urethane rubber, an acrylate rubber, a silicone rubber, a fluorinated rubber, a styrene-block copolymer, a thermoplastic elastomer polyolefin, a thermoplastic elastomer polyvinylchloride, a thermoplastic elastomer polyurethane, a thermoplastic elastomer polyester, a thermoplastic elastomer polyamide, a thermoplastic elastomer fluorinated resin and a natural rubber.

The polymer matrix may also include perfluorosulphonic acid, polytetrafluoroethylene, perfluoroalkoxy derivatives of polytetrafluoroethylene, polysulfone, sulfonated styrene-butadiene copolymers, polychlorotrifluoroethylene (PCTFE) perfluoroethylene-propylene copolymer (FEP), ethylene-chlorotrifluoroethylene copolymer (ECTFE), polyvinylidenefluoride (PVDF), copolymers of polyvinylidenefluoride with hexafluoropropene and tetrafluoroethylene, copolymers of ethylene and tetrafluoroethylene (ETFE), polyvinyl chloride, polystyrene, polyvinylchloride, plasticized polyvinylchloride, polymethylmethacrylate, plasticized polymethylmethacrylate, a polymethylmethacrylate/cellulose-acetyl-butyral mixture, a silica gel, a sol gel, a hydrogel, a silicone, poly-.alpha.-methylstyrene, a polysulfone, ethyl cellulose, cellulose triacetate, polytetrafluoroethylene, a polyester, polybutadiene, polystyrene-co-butadiene, polyurethane, polyvinylbutyral, polyethylacrylate and poly-2-hydroxyethylmethacrylate or mixtures thereof.

The gas permeable polymer matrix may include one or more monomers including poly(amides), poly(acrylamides), poly(styrenes), poly(acrylates), poly(alkylacrylates), poly(nitriles), poly(vinyl chlorides), poly(vinyl alcohols), poly(dienes), poly(esters), poly(carbonates), poly(siloxanes), poly(urethanes), poly(olefins), poly(imides), and cellulosics.

The components of the present invention may be cured in some embodiments either individually or in combination. The curing process removes aggregation of the Ruthenium dye in the polymer matrix. The polymer solubilizes the dye, dispersing the dye more uniformly. Plasticizers may also be used to solubilizes the dye, dispersing the dye more uniformly.

The polymer, the ruthenium(II) compound, the plasticizers may be substituted with an aryl, lower alkyl, alkoxy, alkylcarbonyl, alkoxyalkyl, hydroxy, hydroxyalkyl, alkenyl, amino, “nitrate, alkylamino, dialkylamino, nitroso, aryl, alkylaryl, arylalkoxy, cycloalkyl, bridged cycloalkyl, cycloalkoxy, arylthio, alkylsulfinyl, caboxamido, carbamoyl, carboxyl, carbonyl, halogen, halo, haloalkyl, haloalkoxy, heteroaryl, heterocyclic ring, arylheterocyclic ring, heterocyclic compounds, amido, alkylamido, carboxylic ester, carboxylic acid and halogen.

The present invention also provides a food packaging membrane for detecting one or more analytes within a package. The food packaging membrane includes a diffusible polymer matrix membrane having a ruthenium-based luminescence compound dispersed within a diffusible polymer matrix. The food packaging membrane may include multiple ruthenium-based luminescence compounds of similar or different types dispersed within the same diffusible polymer matrix. Similarly, the diffusible polymer matrix may include multiple monomers of similar or different types to form a unique diffusible polymer matrix. The ruthenium-based luminescence compound has one or more optical properties and interacts with one or more analytes that modify the optical property of the ruthenium-based luminescence compound to provide information on the one or more analytes.

Generally, the ruthenium-based luminescence compound is on, about or within the membrane or in combination thereof. The membrane has numerous uses including forming affixable sensors, coverings for containers or at least a portion of a container and enclosures themselves.

In addition, the present invention provides an optical sensor system. The system includes an indicator capable of emitting an optical signal. The indicator includes a luminescence ruthenium compound dispersed within a gas permeable polymer matrix, wherein exposure to one or more diffusible agents modifies the optical signal of the ruthenium-based luminescence compound. The system also includes a transceiver positioned to detect one or more signals from the luminescence ruthenium compound. Generally, the transceiver is able to send one or more signals and/or receive one or more signals.

The present invention includes a transceiver positioned to detect one or more signals from the luminescence ruthenium compound. Generally, the transceiver (or transmitter and detector) is portable, handheld, integrated into a production line, integrated into a scanner or combination thereof. Alternatively, the transceiver may include a separate transmitter and detector module. Generally, the transceiver emits one or more excitation signals between about 440 nm and 480 nm and detects one or more emission signals in the range of about 580 nm to about 640 nm. However, the transceiver may emit one or more excitation signals within any convenient range and detects one or more emission signals with in any convenient range. In addition, the present invention may include a package transceiver module that receives a signal correlating to the one or more packets of information encoded on the tag. The package transceiver module further includes a display in communication with the package transceiver module.

In one embodiment, the emission source is constituted by LEDs. The LED semiconductor body or bodies may contain GaN, InGaN, AlGaN, ZnS, InAlGaN, ZnSe, CdZnS, or CdZnSe semiconductor material and emit visible light or infrared or ultraviolet electromagnetic radiation. The present invention is not limited to the LED semiconductor compositions disclosed herein, as the skilled artisan will recognize that other LEDs compositions may be used to produce the desired illumination. Other embodiments, a filter may be used to enhance the contrast, reduce the extraneous light, filter the light and combinations thereof.

The emission source includes one or more arrays of LEDs arranged to form an array that excite the luminescence compound. The device may include filters to remove the effect of extraneous light. In some instances, one or more of the LEDs emit at about 460 nm; however, other sources include LEDs that emit at between about 400-450 nm, 450-500 nm, 500-570 nm, 570-590 nm, 590-610 nm, 610-780 nm and combinations and mixtures thereof.

The present invention includes an information display in communication with the package transceiver module to display an analyte concentration that corresponds to the one or more analyte modifiable optical properties of the ruthenium-based luminescence compound. The display correlates the one or more analyte modifiable optical properties to analyte concentration.

In addition the present invention may include a tag. The tag may be optically encoded, magnetically encoded, electrically encoded or a combination thereof. The tag may be a barcode, RFID tag, magnetic strip or a combination thereof. The tags are configured to be capable of identifying the various information about the package or enclosure disposed therein or thereon. Specifically, the tag can be a radio frequency identification (RFID) tag or a barcode. The tag may be a barcode that is read by a barcode reader that generates a low-power laser signal that is reflected off a paper label that includes a UPC. The reflected signal is converted to digital information that can be interpreted by a computer. The present invention also provides a tag that can be used to correlate information in a tag affixed to the enclosure.

In addition, the present invention may itself be made into a tag by applying the ruthenium-based luminescence compound having one or more optical properties dispersed within a gas permeable polymer matrix in the form of a barcode. This embodiment will allow the encoding of more information in the barcode and detecting one or more analytes within a packaging.

The present invention also includes a recorder module in communication with the package transceiver module to store one or more packets of information encoded on a tag, the one or more analyte modifiable optical properties, or combination thereof. The present invention includes a transmitter module in communication with the package transceiver module to broadcast one or more packets of information encoded on the tag, the one or more analyte modifiable optical properties, or combination thereof.

The information display is in communication with the package transceiver module to display an analyte concentration that corresponds to the one or more analyte modifiable optical properties of the ruthenium-based luminescence compound. The present invention also includes a recorder module in communication with the package transceiver module to store the one or more packets of information encoded on the barcode, the one or more analyte modifiable optical properties, or combination thereof.

The transceiver can also be integrated as part of a wireless device such as a PDA, phone, laptop or other mobile or wired device. The transceivers may be networked together and communicate with one or more processors, computers or storage devices. Tag and or transceivers can include short-range communication capabilities such as Bluetooth and WIFI. For example, a warehouse may be made take advantage of location context information tags to each item, and incorporate a tag reader and a location-aware computer system into the manufacturing, processing, storing or transportation equipment. For example, a new container is filled and the concentration of the gases within the container is recorded and stored. The stored information may be stored on the tag attached to the container or in a remote location and associated with the tag. Some embodiments of the present invention includes an information display in communication with the package transceiver module to display the one or more packets of information encoded on the tag.

In one specific example, the transceiver emits one or more excitation signals between about 440 nm and 480 nm and detects one or more emission signals in the range of about 580 nm to about 640 nm. The transceiver further includes a display in communication with the transceiver to correlate the one or more analyte modifiable optical properties to analyte concentration. The transceiver is portable, handheld, integrated into a production line, integrated into a scanner or combination thereof.

The present invention also includes a package monitoring system having a sealable package in communication with a ruthenium-based luminescence sensor, a tag on, in or about the sealable package, and a package transceiver module positioned to detect one or more signals. The ruthenium-based luminescence sensor includes a luminescence ruthenium compound having one or more analyte modifiable optical properties dispersed within a gas permeable polymer matrix. Exposure to one or more analytes affects the one or more analyte modifiable optical properties of the ruthenium-based luminescence compound. The tag is positioned on, in or about the sealable package and encodes one or more packets of information. The type and amount of information displayed on the tag may vary depending on the type of tag and on the type of information. The package transceiver module is positioned to detect one or more signals from the luminescence ruthenium compound.

In one embodiment, the package transceiver emits one or more excitation signals between about 440 nm and 480 nm and detects one or more emission signals in the range of about 580 nm to about 640 nm. The skilled artisan will recognize that other wavelengths may be used depending on the particular constitutes.

The package transceiver module may also be configured to receive a signal correlating to the one or more packets of information encoded on the tag. For example the reader may be a scanner or a RFID detector. The tag is optically encoded, magnetically encoded, electrically encoded or a combination thereof. The tag is a barcode, RFID tag, magnetic strip or a combination thereof.

The package transceiver module may further include a display in communication with the package transceiver module. An information display in communication with the package transceiver module may be used to display the one or more packets of information encoded on the tag. The information display in communication with the package transceiver module may also be used to display an analyte concentration that corresponds to the one or more analyte modifiable optical properties of the ruthenium-based luminescence compound.

The present invention may also include a recorder module in communication with the package transceiver module to store the one or more packets of information encoded on the barcode, the one or more analyte modifiable optical properties, or combination thereof. A transmitter module in communication with the package transceiver module may also be included to broadcast one or more packets of information encoded on the tag, the one or more analyte modifiable optical properties, or combination thereof.

A method for detecting exposure to one or more gases within a container is provided by the present invention. One or more optical properties of a luminescent ruthenium compound are detected. The luminescent ruthenium compound is dispersed in a gas permeable polymeric material and positioned within a container. The luminescent ruthenium compound has one or more optical properties that are modified by exposure to one or more gases. The one or more optical properties of the luminescent ruthenium compound are then correlated to exposure to one or more gases.

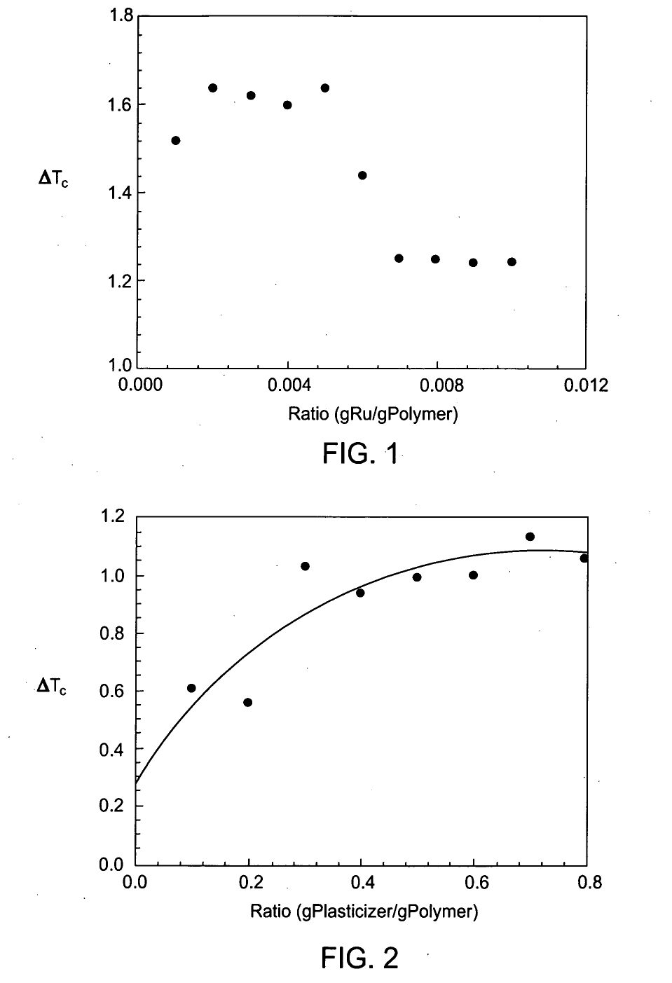

FIG. 1 is a graph of the time constant verses the luminescence indicator/polymer ratio. FIG. 1 provides a measure of the ratio of the total grams of luminescence indicator versus polymer required to obtain the highest change in fluorescent lifetime time constant. The change is a measure of the fluorescent lifetime time constant difference for the sensor material at about 0% and about 30% Oxygen, respectively.

FIG. 2 is a graph of the time constant verses the plasticizer content in the polymeric system. FIG. 2 provides a measure of the ratio of the total grams of plasticizer versus polymer required to obtain the highest change in fluorescent lifetime time constant. The change is a measure of the fluorescent lifetime time constant difference for the sensor material at about 0% and about 30% Oxygen, respectively.

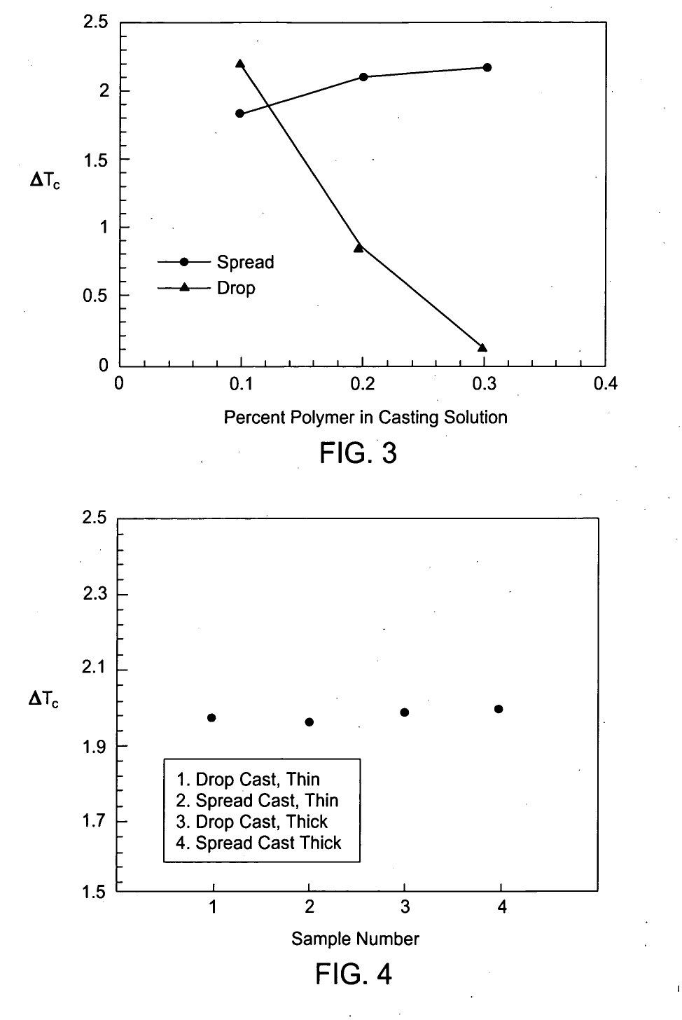

FIG. 3 is a graph of the percent polymer in solution with optimized dye and plasticizer composition as a function of application method. FIG. 3 provides a measure of the percent polymer in the cast solution required to obtain the highest change in fluorescent lifetime time constant. Two application methods were used consisting of spreading a thin layer of polymer compared to simply drop casting the material without spreading. The change is a measure of the fluorescent lifetime time constant difference for the sensor material at about 0% and about 30% Oxygen, respectively.

FIG. 4 is a graph of the post cure response of sensor material as a function of preparation method. FIG. 4 provides a measure of the post cure sensor material for two application methods, e.g., spreading the polymer and drop casting the material without spreading. Volumes for the thin drop and spread cast were half that of the thick drop and spread cast. The change is a measure of the fluorescent lifetime time constant difference for the sensor material at about 0% and about 21% Oxygen, respectively.

The non-invasive oxygen measurement technique is based upon the fluorescence quenching of a metal organic fluorescent chromophore immobilized in a gas permeable hydrophobic polymer. The fluorescent chromophore absorbs light in the blue region of the spectrum and fluoresces within the red region of the spectrum. The presence of oxygen quenches the fluorescent light from the fluorescent chromophore, as well as its lifetime. The change in the emission intensity and lifetime is related to the oxygen partial pressure and can be calibrated to determine the oxygen concentration.

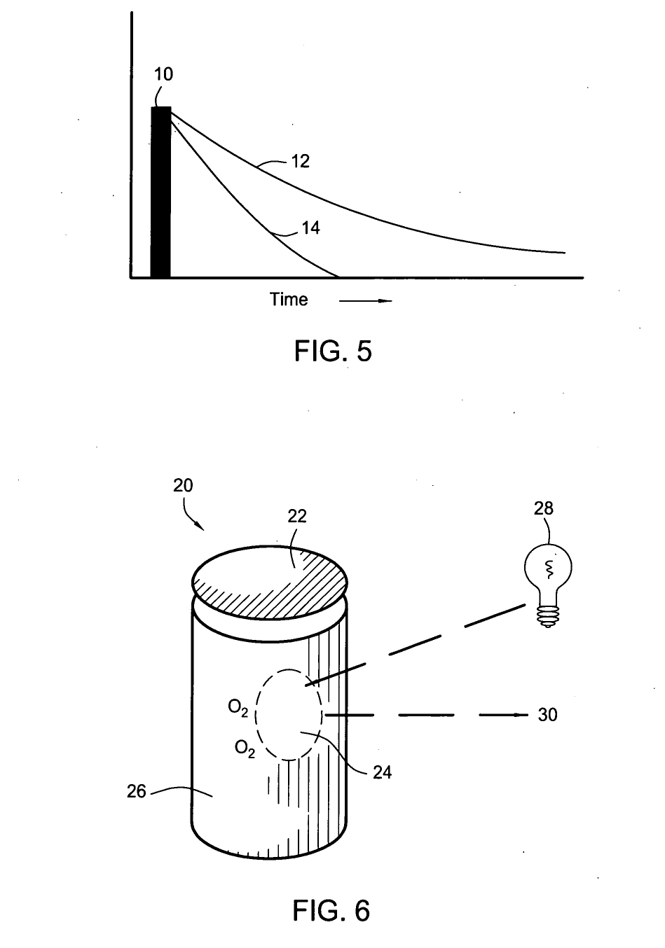

FIG. 5 is a schematic of the oxygen measurement using fluorescence decay. The oxygen concentration can be measured within a sealed package by placing a piece of the fluorescent dye polymer within the package and measuring the emission from outside the package. As long as the packaging material has transmission in the blue and red regions of the spectrum, non-invasive oxygen measurements can be made. The Light pulse 10 excites the metal organic fluorescent chromophore and results in an emission in the form of a fluorescence decay with respect to time in the absence of oxygen 12 and in the presence of oxygen 14.

FIG. 6 is a general schematic of the oxygen sensitive luminescence indicator reading device 20 of the present invention. The oxygen sensitive reading device 20 includes the enclosure 22 that has a luminescence indicator 24 containing a luminescence compound dispersed within a polymer matrix and affixed to the enclosure 22 within the internal environment 26 of the enclosure 22. An emission source 28 is used to excite the luminescence indicator. 24, which emits a signal detectable by the detector 30. The luminescence indicator 24 emits a signal (e.g., fluorescence) that is proportion to the oxygen concentration in the enclosure 22.

The present invention also provides an oxygen sensitive luminescence indicator reading device that can measure oxygen content of a package using the fluorescence lifetime quenching principle. The oxygen sensitive luminescence indicator reading system determines the oxygen concentration within a sealed package by measuring the fluorescence generated upon illumination of an oxygen-sensitive luminescence indicator in the form of an internal film or label. The luminescence indicator can be manually attached to the inside of a package or pre-fabricated into the barrier coating of the package material.

In one embodiment, the excitation source 28 is selected to have an emission at the absorption peak of the luminescence indicator 24. This can be in the form of a lamp with filters, an LED, a laser diode or a combination thereof. The luminescence indicator 24 is illuminated from the outside of the enclosure 22 with appropriate wavelength (e.g., about 470 nm). The light is absorbed by the luminescence indicator 24 and emitted as a result of the fluorescence phenomena of the luminescence compound at a longer wavelength (e.g., about 610 nm). The emission is detected by the detector 30 using a photo-multiplier, photo-diode or similar detector.

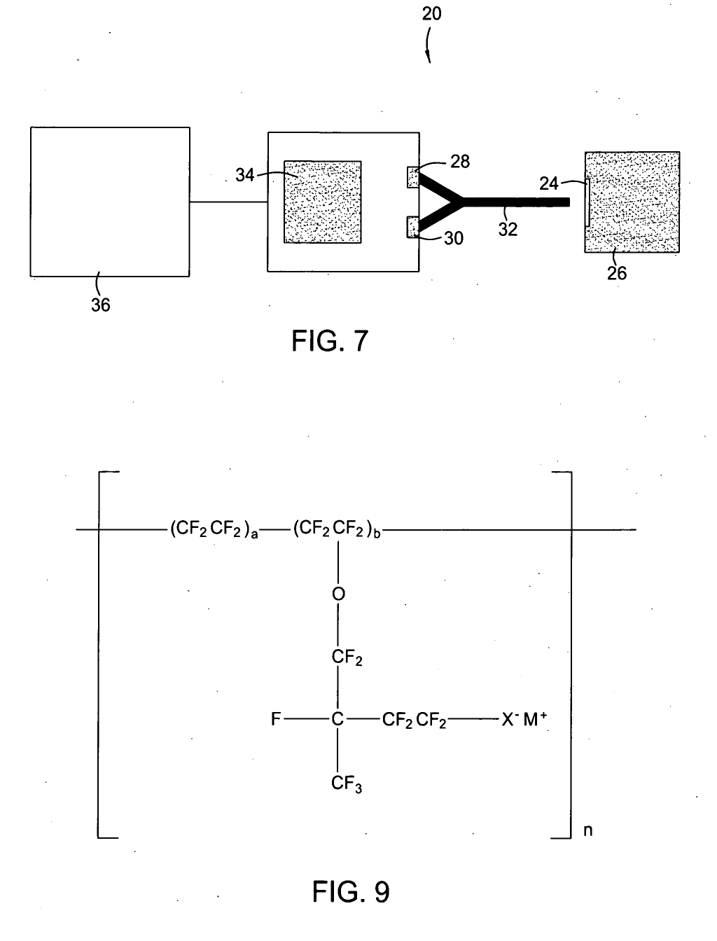

FIG. 7 is a schematic that illustrates one embodiment of the oxygen sensitive luminescence indicator reading device 20 of the present invention that includes the excitation from the emission source 28 is brought to the luminescence indicator 24 by a fiber bundle 32 or other light conducting device. The luminescence indicator 24 is positioned within the enclosure 22 and in contact with the internal environment 26. The emission from the luminescence indicator 24 is brought to the detector 30 using the same fiber optic bundle 32. The oxygen sensitive luminescence indicator reading device 20 may be connected to a computer 36 or CPU. The fluorescence decay time is measured using the electronics in the instrument and this related to the oxygen concentration using the Stern-Volmer equations.

The present invention provides a method for preparing a poly-acrylate polymer using a modified procedure or improvement of U.S. Pat. No. 5,387,329. For example, the following compounds were added in the following order to a 500 ml round bottom glass flask:
18.92 g acrylonitrile
39.42 g 2-ethylhexylacrylate
57.12 g methylmethacrylate
24.54 g vinyl acetate
0.140 g azo-bisisobutyronitrile
   An egg shaped stir bar 0.25″×0.625″ was added to the solution and the reaction vessel was capped with a rubber septum. The head-space was then flushed with Argon (5.0 Ultra High Purity) for about 20 minutes. An argon balloon attached to a 3 cc syringe was used to pierce the rubber septum. The balloon remains filled to provide positive pressure of Argon to the system. The system was heated to a constant pressure between about 65-75° C. for about 42 hours.

The polymer may be recrystallized in methanol before dissolving in suitable solvent to form the luminescence indicator; however both recrystallized and non-recrystallized polymers are found to make no difference in response from luminescence indicators produced from each material. One example of the preparation includes a product that is first dissolved in a suitable solvent system to produce a liquid polymer solution. A 250 ml aliquot of ethyl acetate is added in 50 ml portions to dissolve the solidified polymer. The percent polymer in the solution must be determined to ensure a final concentration of about 0.10 grams polymer/1 ml polymer solution. Ethyl acetate is evaporated or added to produce the 10% polymer solution. The final product is the polymer used in the formulation and preparation of the luminescence indicator.

The luminescence indicator includes a minimum of three components: polymer solution, luminescence compound (e.g., ruthenium-based) and plasticizer. FIG. 1 displays the influence of the dye concentration on the sensor response. The concentration may range from between about 0.002 grams and about 0.005 grams luminescence compound per gram of polymer. The plasticizer concentration obtained from FIG. 1 may be between about 0.4 and about 0.5 grams plasticizer per gram of polymer. In embodiments where the sensor solution is spread out there is no change in the response as a function of the percent polymer; however, drop preparations show a change in the response as a function of the percent polymer. The change in the fluorescent lifetime decreases rapidly reaching zero at about 30 percent polymer. The data indicates that the thickness of the polymer is such that oxygen does not readily quench the dye embedded in the polymer as the concentration is increased. Since the emission source 28 irradiated the back-side of the luminescence indicator, not all of the dye is excited by the radiation or the thickness is sufficient that the dye is not effectively quenched by oxygen permeating the membrane.

The '736 patent states the indicator substances of the above type may be incorporated into a polymer by one of the following methods: Indicator substances should be chosen such that they are themselves soluble in a solvent for the selected polymer, and a common solution should be prepared of the indicator substance and the polymer. After evaporation of the common solvent, the polymer containing the indicator substance will remain. Apart from a common solvent, a polymer suspending agent may be used, provided that his agent is again suited as a solvent for the indicator substance. If polymerization of the employed polymer is taking place in a reaction mixture of several components, one of these components may be used as a solvent for the indicator substance at the same time. This simple, conventional procedure entails a number of problems, making indicator molecules, which are incorporated into polymers in this manner, unsuitable for the purpose of the present invention. For example, evaporation of the common solvent will not lead to a molecular distribution of the indicator substance in the polymer but will cause the indicator substance to crystallize out in the polymer. Although the crystallized indicator substance in the polymer will exhibit fluorescence, this fluorescence will not be influenced—at least not to a useful degree—by the presence of molecular oxygen. Besides a fine distribution of microcrystals in the polymer, large aggregates of crystalline indicator substance were observed to build up in the polymer. Even if there is a molecular distribution of the indicator substance in the polymer, which may be noted in certain cases (e.g., with polyvinylchloride solutions) the indicators incorporated in this manner will exhibit no fluorescence quenching due to molecular oxygen.

The aggregation of dye and lack of homogeneity is observed in FIG. 3, where the thickness of the polymer and distribution of the dye are such that quenching is not observed for thick samples. However, there is indeed observable signal for the fluorescence quenching by oxygen in conflict with the statements reproduced above from '736 patent.

The present invention provides a method of curing to produce more homogenous sensor material. The ruthenium-based luminescence indicator containing polymer, luminescence compound (e.g., ruthenium-based) and plasticizer was cured at elevated temperature under vacuum conditions. The result was a solvent free ruthenium-based luminescence indicator that was then stored in airtight containers until use. To ruthenium-based luminescence indicator for casting a 2 gram portion of the cured material was dissolved in 10 ml of ethyl acetate. The resulting solution was cast in the same manner used to produce the data in FIG. 3. The change in lifetime due to oxygen quenching of the luminescence compound in the polymer is present in FIG. 4. The methods show no dependence of application of the material or thickness of the application. In fact, the sensor response is standardized. The present invention provides the dye be homogenously distributed throughout the ruthenium-based luminescence indicator with thermal curing. The present invention also specifically refutes the previous statement above indicating that homogenous distribution of dye in the polymer is not sufficient to observe oxygen quenching. In addition, the present invention suggests that the luminescence compound is sufficiently soluble in the polymer matrix to ensure that the quenching of oxygen influences the change in fluorescent lifetime observed for the sensor material.

Monitoring oxygen levels is of great importance in environmental and biomedical analysis as well as industrial processes¹⁻⁸. The amperometric method using an oxygen electrode has been the most popular technique in the past decade;¹ however, amperometric methods are limited by the materials used, including the stability of the electrode surface and instabilities in the oxygen diffusion barrier. In addition, the response time of electrochemical sensors are limited by gas permeability through semi-permeable membranes.

In the past decade there has been considerable interest in luminescence based optical oxygen sensors.¹⁻⁵ One significant advantage of photoluminescent sensors over electrochemical sensors is their ability to work in the presence of electromagnetic disturbances. In contrast, the response of photoluminescent sensors is much faster because it does not necessarily require gas permeable separation membranes. Generally, oxygen permeable membranes are typically used to exclude unwanted species in photo luminescent sensors. Therefore, the inherent permeability of oxygen through optical sensing membrane is important in monitoring oxygen quenching using membranes. Additionally, the photoluminescent sensor uses optical fibers can be used in the device fabrication, which enables micro dimensions to be achieved.⁶

The present invention provides an optical sensing platform that utilizes polymer/ruthenium complex composites as the sensing transducer. The detection method utilizes fluorescence of the ruthenium complex embedded in a selectively (e.g., oxygen) polymeric membrane. In one embodiment, the sensor is an optical oxygen sensing device which can be used in food industry.

Most optical sensors utilize the luminescence quenching of an indicator dye in the presence of the target analyte (oxygen, hydrogen, carbon dioxide, etc.)^{1,3,11,14}. Dyes that have been used in optical sensors include luminescent and oxygen quenchable organic dyes, such as polycyclic aromatic hydrocarbons (pyrene derivatives, quinoline and phenanthroline)⁶⁻⁹, transition metal complexes of ruthenium¹⁻⁵, osmium or rhenium-polypyridyl and metalloporphyrines¹⁰. In most optical oxygen sensors these indicators are dispersed in oxygen permeable polymer or sol-gel matrices that are tailored to enhance or inhibit interactions with different species.

Polymers may be used for the present invention to provide relatively low cost, sensors that use conventional fabrication techniques in conjunction with various types of substrates. The sensors produced using polymer materials are typically operable and stable at room temperature.¹¹ There is a growing literature on the development of an optical sensors on a variety of materials including silicon, polystyrene, nafion, poly(acrylic acid), zeolites etc.¹⁻⁵

Interactions between the luminescent complexes and the polymer are often complex and they can affect the ultimate performance of the sensor. For example, the influence of polymer concentration in the casting solution, dye concentration, and plasticizer concentration may be optimized individually.

One embodiment of the present invention provides an optical oxygen sensor having a luminescent ruthenium(II)polypyridyl complex immobilized in organic polymers, e.g., nafion, polystyrene and polyacrylate. Optical sensing methods that utilize the fluorescence of dye molecules (e.g., luminescence compound) can measure the quenching of a chromophore using two different parameters, e.g., quenching and lifetime. The most common method of measurement to date involves monitoring the luminescence intensity quenching. In addition, the fluorescence lifetime can be utilized for quenching phenomena; however, this technique typically requires specialized instrumentation and algorithms for fitting the fluorescence decay of the chromophore. The ruthenium(II)polypyridyl complexes provide strong emission signal with sufficiently long lifetimes to be measured. The relationship between the emission intensity or the lifetime and the oxygen concentration can be explained using the Stern-Volmer equation, which is the basis for the treatment of oxygen quenchable fluorescent chromophores that have been used in oxygen sensors and a wide variety of sensing applications.^{1-5 and 12}.

Ruthenium(II)polypyridyl complexes (Ru(bpy)₃²⁺) has been one of the most extensively studied chromophores in past decade.¹³⁻²² A unique combination of stability, measurable redox properties, excited state reactivity, luminescence emission and excited state lifetime resulted in a large volume of research on this molecule and many of the derivatives have been produced from this initial molecule.¹³

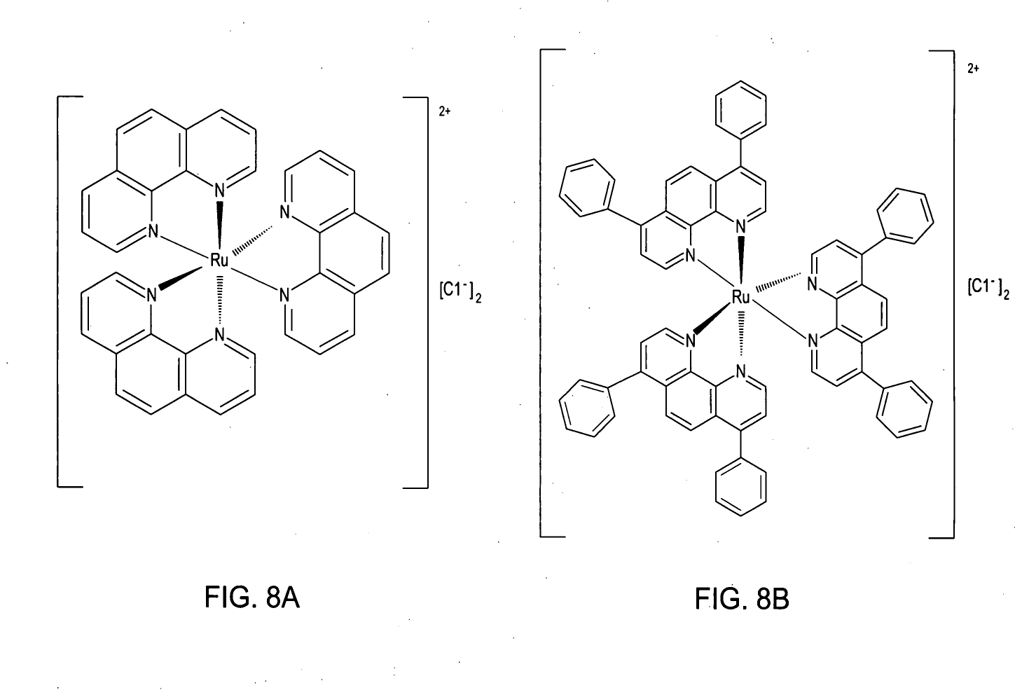

Generally, ruthenium(II) is a d6 transition metal, which forms octahedral complexes with a bidentate ligand polypyridine. Polypyridyl complexes of ruthenium(II) are colored due to an intense metal-to-ligand charge transfer band (MLCT) at about 440 nm and frequently displays photoluminescent band at about 610 nm upon excitation into this MLCT band.¹⁴ FIG. 8 illustrates 2 of the numerous ruthenium(II) complexes. Tris(1,10-phenanthroline)ruthenium(II)dichloride complex [Ru(Phen)₃²⁺](Cl₂) and tris(4,7-diphenyl-1,10-phenanthroline)ruthenium(II)dichloride complex [Ru(Ph₂Phen)₃²⁺](Cl₂).

Polymer materials have been used by analytical chemists to construct a wide variety of sensors for oxygen, sulfur dioxide, ethanol and water vapor.²² Polymer films containing luminescent dyes are widely used in oxygen sensors.¹⁻⁵ The polymer matrix serves to bind the dye and as a medium for oxygen transport from the surrounding environment. The polymer can also act as an impermeable barrier preventing the uptake of water or other unwanted species. Generally, to maximize the effectiveness of the sensor, the polymer should have relatively high oxygen permeability and the polymer-dye combination must be miscible. However, the skilled artisan will recognize that other polymers and characteristics may be desirable. Although it is often assumed that the transition metal complex is homogenously distributed throughout the polymer matrix, heterogeneous regions can be used in the present invention.

In some embodiments, plasticizers can be added to the polymer to prevent dye aggregation, increase oxygen permeability and increase the sensitivity of the sensor. Furthermore, the solvent used to dissolve the polymer and the dye has to be carefully selected because the dye molecules and the polymer should miscible with each other. A solvent that dissolves all three components of the sensor, the ruthenium(II)polypyridyl complex, polymer and the plasticizer, is preferred but other solvents, solvent mixtures, solvent gradients or solvent compositions may be used.

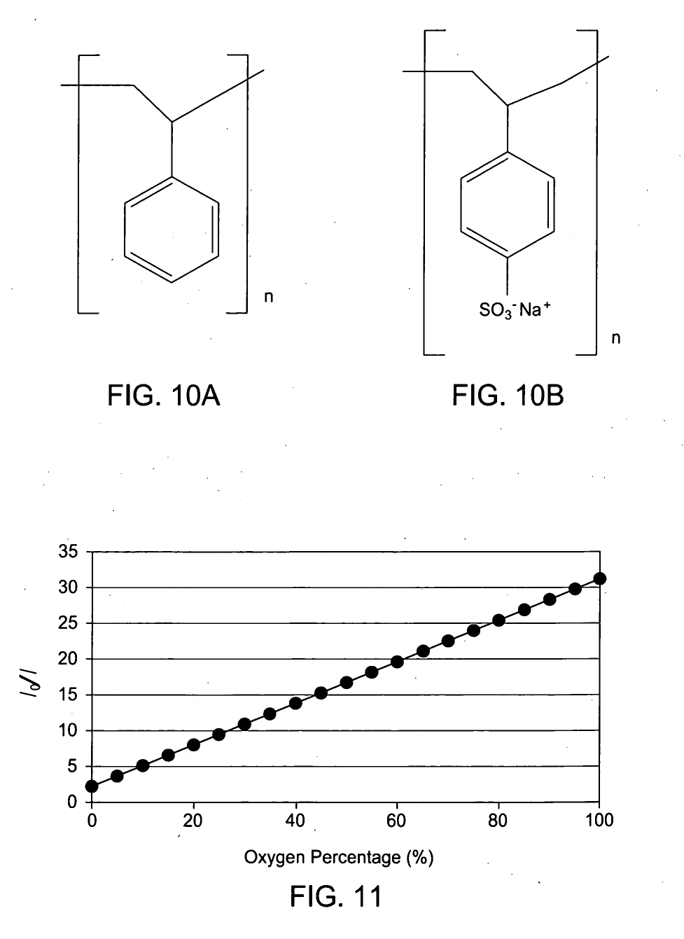

Some examples of polymers include nafion, polystyrene, poly(sodium-4-styrene sulfonate) and polyacrylate polymers. In addition, these polymers were doped with the well known² oxygen sensing dye tris(4,7-diphenyl-1,10-phenanthroline) complex. FIG. 9 is an illustration of a Nafion monomer²³ that is a perfluorinated polymer which has thermal stability (e.g., to about 200° C.), mechanical strength, ease of handling and general chemical and biological inertness.²⁰ In addition, the polymer is conductive and can be used in both optical and electrochemical sensing regimes. FIG. 10A illustrates another polymer, polystyrene, which is a well known neutral polymer matrix that has been used for variety of sensor applications.^{1,11,21} FIG. 10B illustrates a poly(sodium-4-styrene) sulfonate anionic polymer. The advantage of using the anionic polymer includes the positively charged ruthenium(II)polypyridyl complexes are electrostatically attached to the polymer to prevent leaching of the complex from the sensor film. Anionic polymers contain chemical functional groups that facilitate the electrostatic immobilization of the dye molecule.¹ A polyacrylate polymer, which is a heterogeneous polymer containing four different monomer units was also used to develop the oxygen sensors based on the high oxygen permeability of the material.²⁴

Optical oxygen sensing properties of sensor films. Studies have shown that unlike solvents, polymers have inhomogeneous structure (e.g., architecture in which the elements are of different types) that is influenced by the absolute molecular weight and molecular weight distribution.¹⁰ This inhomogeniety can drastically affect the sensitivity, selectivity and limit of detection of the sensor as it applies to Stern-Volmer kinetics.¹⁰ The inhomogeniety results nonlinear Stern-Volmer plots. Demas, DeGraff and Xu reported a multi-site model and nonlinear solubility model to explain the results of downward curvature in the Stern-Volmer plots at higher oxygen concentrations. The nonlinearity of the Stern-Volmer plots can be found in literature on optical sensor studies.¹⁻⁶ Sensors which utilize, Stern-Volmer bimolecular quenching kinetics can be described using the following scheme:

D+hv→D* (1a)

D*→D+hv or Δk₁ (1b)

D*+Q→D+Q*k₂ (2a)

D*+Q→D+Q+Δ (2b)

For Stern-Volmer systems D represents the ground state chromophore, Q is the ground state quencher, k₁ is the rate constant for the decay of the excited state chromophore when the quencher is absent and k₂ is the rate constant for the decay of the excited state chromophore when the quencher is present. The possible bimolecular processes involving the quencher Q are shown in equations 2a and 2b. Equation (2a) shows the deactivation of the excited chromophore by transferring energy to Q and (2b) shows deactivation of D without excitation of Q.

The kinetic scheme gives Stern-Volmer equation, which describes the dynamic quenching of the fluorophore. For optical oxygen sensors, oxygen is the quencher. The Stern-Volmer equation gives the relationship between the intensity or lifetime and the quencher concentration.

I₀/I=1+Kₛᵥ[O₂] (3a)

τ₀/τ=1+K[O₂] (3b)

Kₛᵥ=k₂τ₀ (3c)

τ₀=1/k₁ (3d)

τ=τ₀/1+Kₛᵥ[O₂] (3e)

Where I is the emission intensity in the presence of oxygen, Iₒ is the emission intensity in the absence of oxygen, τ is the luminescence lifetime in the presence of oxygen, τ₀ is the luminescence lifetime in the absence of quencher oxygen and Kₛᵥ is the Stern-Volmer quenching constant. The unit of the Kₛᵥ is the reciprocal of oxygen concentration (%⁻¹). A linear calibration curve results for the plot of I₀/I versus oxygen concentration and τ₀/τ versus oxygen concentration based on equation (3a).

The luminescence decay curves for the ideal Stern-Volmer relationship are all single exponential curves with a measured quencher-dependent lifetime.¹² Most of the sensor studies have been done using luminescence intensity. The relationship between the intensity and the lifetime is as follows:

τ₀/τ=I₀/I (4a)

τ=τ₀/(I₀/I) (4b)

FIG. 11 is a theoretical Stern-Volmer plot for Ru(Ph₂Phen)₃²⁺. The theoretical Stern-Volmer plot produces a linear relationship between the relative intensity and oxygen concentration. In FIG. 11, the Stern-Volmer plot produces a linear relation, for Ru(Ph₂Phen)₃²⁺ () attached to poly(acrylic acid) films, where Kₛᵥ=0.3015 (%⁻¹).

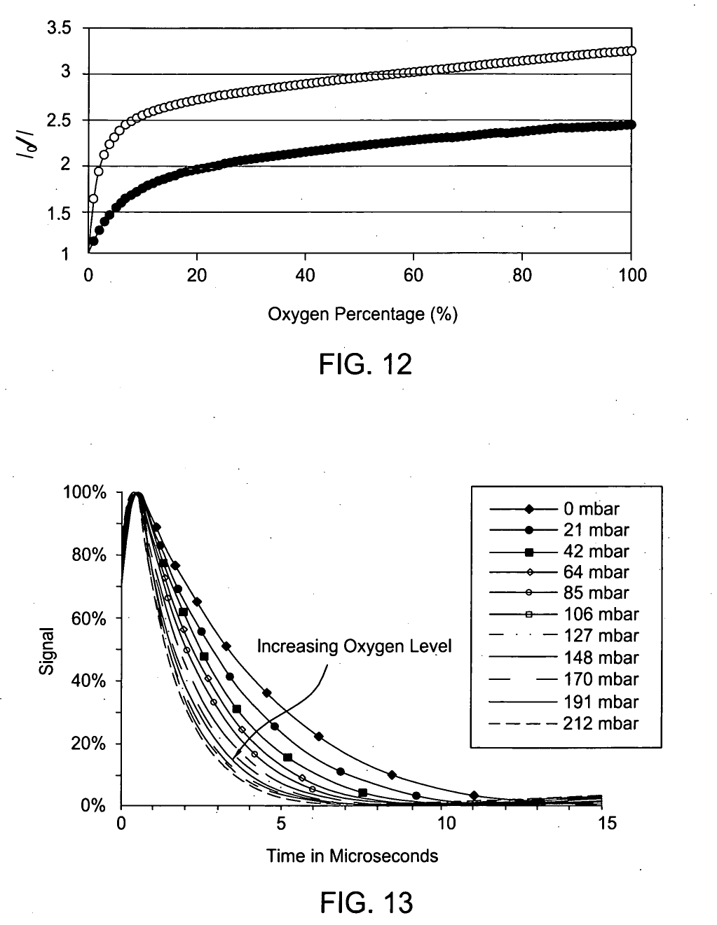

FIG. 12 is a theoretical nonlinear Stern-Volmer plot using equation 5(a). In the equation, fₙ is the fractional contribution to each oxygen accessible site, where there are two sites in the sensor film. Ksvₙ is the Stern-Volmer quenching constant for each oxygen accessible site. I and I₀ represent the luminescence intensity in the presence and absence of oxygen.

$$\frac{{I}_{O}}{I} = [ \sum \frac{fn}{( 1 + {K}_{{sv}_{n}} [ {O}_{2} ] )} ] \qquad ( 5 a )$$

FIG. 12 illustrates a non-linear Stern Volmer plot for Ru(Ph₂Phen)₃²⁺ (O), attached to poly(sodium 4-styrene sulfonate) films and Ru(Ph₂Phen)₃²⁺ (▪) attached to poly(acrylic acid) films. Ru(Ph₂Phen)₃²⁺ in poly(sodium-4-styrene sulfonate) Kₛᵥ₁=1.46%⁻¹, f₁=0.64, Kₛᵥ₂=0.0019%−1, f₂=0.36¹. Ru(Ph₂Phen)₃²⁺ in poly(acrylic acid) Kₛᵥ₁=0.300%⁻¹, f₁=0.55, Kₛᵥ₂=0.0015%⁻¹, f₂=0.451.

The time constant (T_{C}) is the time required for the fluorescence decay of the chromophores, which is denoted by τ in the Stern-Volmer equation. The time constant was measured in nitrogen atmosphere for 0% oxygen and compressed air with 20% oxygen. The difference between T_{C} values (ΔT_{C}) was taken. In one embodiment, the oxygen sensor was developed by looking at the ΔT_{C} values, where ΔT_{C}=about 2.0 is the threshold value for an optical oxygen sensing device based.

The measurements were made using the analyzer of the present invention for determining the amount of oxygen contaminant within sealed packages. The Stern-Volmer equation is transported into the analyzer software by equation 6(a). Where T_{C} is the time constant at current oxygen concentration in μs (τ), [O₂] is the oxygen concentration,

A=Kₛᵥ/τ₀ and B=1/τ₀.

1/T_{C}=A[O₂]+B (6a)

FIG. 13 is a graph of the relative fluorescence signals (I₀/I) measured at different oxygen partial pressures at 20° C. using the analyzer of the present invention.²⁶ The [Ru(Ph₂Phen)₃](Cl₂) dye was illuminated at a rate of 1 μs pulses at a frequency of 20 kHz. The fluorescent lifetime lies between 1 μs and 5 μs.

Most solutions satisfy the ideal linear Stern-Volmer relationship. However, most sensors require that the chromophores are supported on a polymer matrix. This is necessary since virtually all luminescent sensors will respond to species other than oxygen (e.g., proteins, surfactants, solvents, metal ions, oxidants, reductants, etc.). Therefore, the sensor must be isolated from these interferences while still providing full access to oxygen. The sensor molecule is isolated from the environments that contain nongaseous solvent born interferences. Therefore, the sensor molecule is typically supported on the gas permeable, solvent impermeable polymer membrane.

Unlike fluid solutions, a polymer supported chromophore system exhibits some degree of heterogeneity due to the differences in occupation by the sensor molecules in the membrane. Heterogeneity manifests itself in nonlinear downward-curved Stern-Volmer quenching plots. Two common explanations of the nonlinearity¹² include multisite binding or the nonlinear solubility properties of the analyte in the sensor. There are two fundamentally different models for quantitation of nonlinear quenching behavior. The first involves the use of a multisite (two-site) model and the second a nonlinear solubility model. In the multisite model, the sensor molecule can exist in two or more sites each with its unique quenching constants. The second model assumes that all nonlinearity in the Stern-Volmer plot arises from the nonlinear solubility of oxygen in the polymer. This is a direct result of the gas permeability issue within the polymer. To minimize the inhomogeniety the polymer and sensing element that is the polymer/chromophore membrane, can be cast, spin coated or chemisorbed onto a surface providing a much more homogenous sensing membrane.

Unlike the present invention (e.g., an optical oxygen sensing platform for closed container food packages), the vast numbers of studies concerning optical oxygen sensors have been focused on diffuse oxygen concentrations in open settings. The same dyes used in previous studies were synthesized and embedded in various polymeric supports. The ruthenium(II)polypyridyl complexes were chosen based on the abundance of studies and applications examined previously.¹⁻⁵

Materials in General. Bathophenanthroline (Alfa Aesar, 98%, 1662-01-7), Ruthenium(III)chloride hydrate (Strem Chemicals, 99.9%, 14898-67-1), N.N-Dimethylformamide (EMD Chemicals, 68-12-2), Acetone (EM Science, 67-64-1), Ethyl ether (VWR International, 60-29-7), Ethyl alcohol (EM Science, 64-17-5), Ammonium hexafluorophosphate (Alfa Aesar, 99.5%, 16941-11-0), 1,10-phenanthroline (Aldrich, 99%, 66-71-7). All materials were used without further purification.

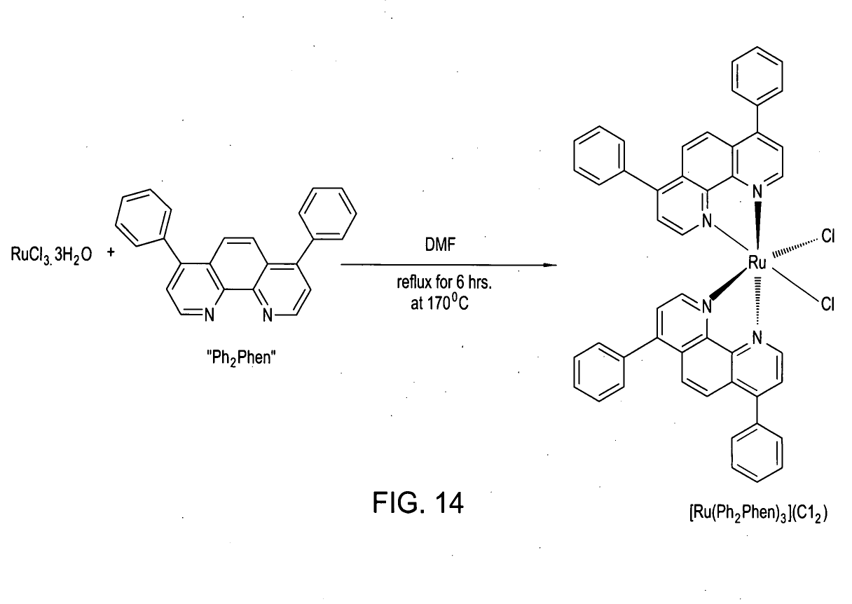

FIG. 14 illustrates a schematic for the preparation of cis-bis(4,7-diphenyl-1,10-phenanthroline)ruthenium(II)dichloride. Synthesis of tris(4,7-diphenyl-1,10-phenanthroline)ruthenium(II)hexafluorophosphate.²⁶ Ruthenium(III)chloride hydrate (e.g., about 1.5631 grams, 5.97 mmol) and 4,7-diphenyl-1,10-phenanthroline (e.g., about 3.9855 grams, 12 mmol) were added to a 100 ml round bottom flask and heated to reflux in dimethylformamide (e.g., about 60 mL) at about 170° C. for 6 hours with stirring. During this period, the reaction mixture becomes dark violet color. After the reaction mixture was cooled to room temperature, 250 ml of HPLC grade acetone was added and the resultant solution and the mixture was cooled at 0° C. overnight. The reaction mixture was filtered using a Buchner funnel and the resultant dark violet-black microcrystalline product was washed three times with 25 ml portions of distilled water followed by three 25 ml portions of ethyl ether. The dark violet color product was dried by suction. Yield of the product was 3.45 grams (4.12 mmol), 69% based on ruthenium(III)chloride hydrate.

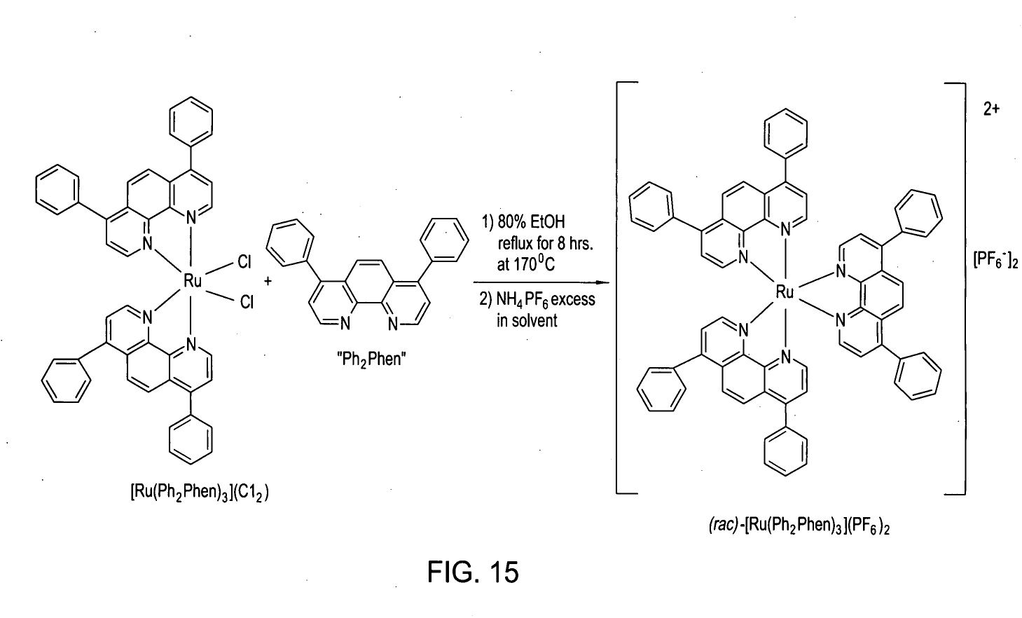

FIG. 15 illustrates a schematic for the preparation of tris(4,7-diphenyl-1,10-phenanthroline)ruthenium(II)hexafluorophosphate complex. In one example, the synthesis of cis-bis(4,7-diphenyl-1,10-phenanthroline)ruthenium(II)dichloride. Bis(4,7-diphenyl-1,10-phenanthroline)ruthenium(II)chloride (1.3514 grams, 1.57 mmol) and 4,7-diphenyl-1,10-phenanthroline (about 0.6561 grams, 1.97 mmol) were added to a 250 ml round bottom flask and heated to reflux in 80% ethanol (about 120 mL) at about 170° C. for 8 hours with stirring. During this period, the reaction mixture becomes red-wine colored. After cooling, the reaction mixture volume was reduced to about ⅓ of the original volume by evaporation under reduced pressure using a rotavap. Distilled water (about 20 mL) was added to the round bottom flask with swirling. The resulting mixture was filtered using a Buchner funnel to remove insoluble material. The dark red filtrate was treated with an excess of ammonium hexafluorophosphate in small portions with stirring to precipitate the product. The red orange precipitate was collected using a Buchner funnel and dried. The product was transferred to a small flask and dissolved in minimal amount of acetone with stirring. Insoluble material was removed by suction filtration using a Buchner funnel. Precipitation of the final product was achieved on slow addition of ethyl ether with stirring. The product was filtered and dried under vacuum. Yield of the product was about 2.15 grams (1.5 mmol), 95% based on the starting bis-ruthenium complex. The product obtained was a racemic mixture of Δ (delta) and λ (lambda) enantiomers.

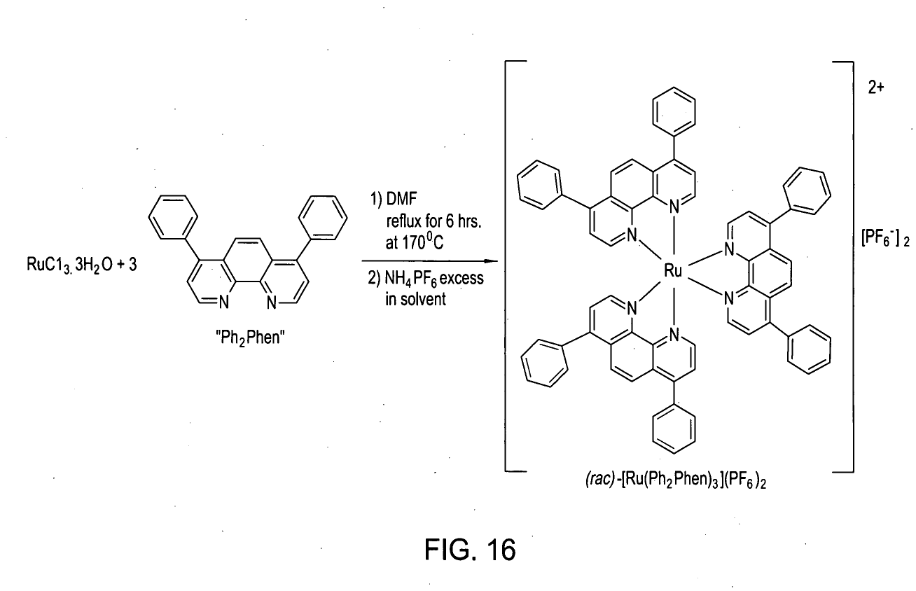

FIG. 16 illustrates a schematic for the preparation of tris(4,7-diphenyl-1,10-phenanthroline)ruthenium(II)hexafluorophosphate complex. In one example, preparation of tris(4,7-diphenyl-1,10-phenanthroline)ruthenium(II)hexafluorophosphate complex including the single step synthesis of tris(4,7-diphenyl-1,10-phenanthroline)hexafluorophosphate complex. Single step synthesis was carried out using the same experimental procedure used for the preparation of bis(4,7-diphenyl-1,10-phenanthroline)ruthenium(II)dichloride, as discussed herein. The yield of the crude product was about 2.82 grams (2.57 mmol), 43% based on the starting ruthenium trichloride. The crude product was purified by column chromatography on silica gel 60 and eluted with MeOH. The purified ruthenium complex from the column was about 6.27% based on starting crude ruthenium complex.

One example preparation of tris(4,7-diphenyl-1,10-phenanthroline)ruthenium(II)hexafluorophosphate complex. Tris(4,7-diphenyl-1,10-phenanthroline)ruthenium(II)hexafluorophosphate, tris(1,10-phenanthroline)ruthenium(II)hexafluorophosphate, bis(1,10-phenanthroline)ruthenium(II)dichloride and bis(4,7-diphenyl-1,10-phenanthroline)ruthenium(II)dichloride were characterized using several conventional techniques. Crude materials were identified using thin layer chromatography (TLC) on silica plates in different solvent combinations. Column chromatography was used to separate the materials using appropriate solvent systems. Melting points²⁷ of the crude products and recrystallized materials were obtained using Thomas Hoover Capillary Melting point apparatus.

Various chemical modification techniques, many of which are conventional and well known in the art, may be employed to functionalize or derivatize the ruthenium-based luminescence compound, the gas permeable polymer matrix or both with one or more atoms or groups to produce a component precursor or modified composition for the luminescence indicator, polymer matrix or both. The analyte sensitivity (e.g., to the gas component of interest) of the luminescence compound may be modified by attaching one or more groups.

Fluorescence Spectroscopic Characterization.³² Fluorescence spectroscopy is used to determine the intense metal-to-ligand charge transfer band due to ruthenium(II)polypyridyl complex. Studies were carried out to determine the emission wavelength of each complex using the Perkin-Elmer LS55 luminescence spectrometer. Both liquid and solid samples were measured. Each sample was scanned at a speed of 1200 nm/minutes and the slit width of excitation and emission was 10 nm. All sample measurements were carried out at room temperature. The tris(4,7-diphenyl-1,10-phenanthroline)ruthenium(II)hexafluorophosphate complex was dissolved in dichloromethane and the sample were excited at 460 nm and the maximum fluorescence intensity was obtained at 600 nm. Literature cited the absorbance at 461 nm and the emission at 610 nm.

UV/VIS Spectroscopy.^{31,32,37} UV/V is spectra were obtained for all synthesized ruthenium complexes using a Cary 3BIO UV/Vis spectrophotometer. A quartz cuvette with a 1 cm path length was used at room temperature for all measurements. UV/VIS spectra were taken for tris(4,7-diphenyl-1,10-phenanthroline)ruthenium(II)hexafluorophosphate complex to determine the wavelength of maximum absorbance. The maximum absorbance wavelength obtained for the [Ru(Ph₂Phen)₃] (Cl₂) in dichloromethane was 462 nm and the [Ru(Ph₂Phen)₃] (PF₆) in dichloromethane was 460 nm under room temperature.

NMR Spectroscopy. Structures of tris and bis ruthenium complexes were confirmed³⁷ by 1H NMR spectroscopy. All NMR data were obtained by using Bruker AMX 400 NMR spectrophotometer.

Preparation of sensor films. Polymers have been used for a variety of chemical sensors such as oxygen, carbon dioxide, sulfur dioxide, water vapor and ethanol.³⁹⁻⁴⁴ The present invention includes the polymers: nafion, polystyrene, poly(sodium-4-styrene) sulfonate and a synthesized polyacrylate polymer,⁷ which used to make sensor films.

The introduction of ruthenium(II)polypyridyl complex into the polymer matrix plays an important role in oxygen sensing.^{40,41,46-51} The concentration of the dye relative to the polymer will be examined. Plasticizers are introduced to optimize oxygen permeation and the oxygen sensing properties of the sensor films. A variety of plasticizers for each polymer matrix may be used and the skilled artisan will know what concentrations and methods of addition may be used for each polymer matrix.

Materials. Acrylonitrile (Aldrich, 99%, 107-13-1), 2-Ethylhexylacrylate (Aldrich, 98%, 103-11-7), Methylmethacrylate (Aldrich, 99%, 80-62-6), Vinyl acetate (Aldrich, 99%, 108-05-4), Azo-bis-isobutyronitrile (Sigma-Aldrich, 98%, 78-67-1), Chloroform (Burdick & Jackson, 67-66-3), Methanol (EM Science, 67-56-1), Poly(sodium-4-styrene sulfonate) polymer (Alfa Aesar, 25704-18-1), concentrated hydrochloric acid (EM Science, 38%, 7647-01-0), isopropyl alcohol (EM Science, 67-63-0), Nafion (Aldrich, 66796-30-3), Polystyrene (Aldrich, 9003-53-6), Poly(acrylic) acid (Aldrich, 9003-01-4), Ethyl acetate (EM Science, 141-78-6), Methanol (EM Science, 67-56-1), Ethyl alcohol (EM Science, 64-17-5), Tris-HCl (Rockland, 1.0M, 1185-53-1), 1-methoxy-2-propanol (Alfa Aesar, 99%, 107-98-2) Dioctyl phthalate (Aldrich, 99%, 117-81-7), Diphenyl isophthalate (Aldrich, 99%, 744-45-6), p-Toluene sulfonic acid monohydrate (Aldrich, 98.5%, 6192-52-5), Phthalic acid benzyl n-butyl ester (TCI America, 98%, 85-68-7), Diphenyl phthalate (Aldrich, 99%, 84-62-8), p-styrene sulfonic acid (TCI America, 80%, 2695-37-6), Allylsulfonic acid sodium salt(TCI America, 2495-39-8), Vinylsulfonic acid sodium salt (TCI Tokyo Kasei Kogyo co. LTD, 25%) were used without purification.

Preparation of polyacrylate polymer.⁴⁵ Acrylonitrile (9.46 grams), 2-ethyl hexylacrylate (19.71 grams), methylmethacrylate (28.56 grams), vinyl acetate (12.27 grams) and azo-bis-isobutyronitrile (0.07 grams) were added to 500 ml round bottom flask. The reaction mixture was stirred using a magnetic stirrer and the flask was capped and saturated with argon. The oil bath was heated to 60° C. and the reaction mixture was placed on the oil bath and heated for 42 hours. The mixture of monomers was polymerized to a solid state. The solid polymer was dissolved in ethyl acetate to produce about 10%-20% (w/w) polymer solution.

Solubility of polymers. The solubility of each solid polymer was determined, by adding about 0.1 mg of polymer into 1 ml of each solvent. The polymers and the solvents used to determine the solubility and the results are presented in Table 1.

TABLE 1

| | | | | Protonated | |
|---|---|---|---|---|---|
| | | | Poly(styrene) | polystyrene | |
| Solvent | Nafion | Polystyrene | sodium salt | sulfonate | Poly(acrylate) |
| MeOH | Not Soluble | Not Soluble | Not Soluble | Not Soluble | Not Soluble |
| EtOH | Not Soluble | Not Soluble | Not Soluble | Not Soluble | Not Soluble |
| i-PrOH | Not Soluble | Not Soluble | Not Soluble | Soluble | Not Soluble |
| EtOH:MeOH:i- | Soluble | Not Soluble | Not Soluble | Not Soluble | Not Soluble |
| PrOH:H₂O | | | | | |
| 3:3:3:1 | | | | | |
| Tris HCl | Not Soluble | Not Soluble | Soluble | Not Soluble | Not Soluble |
| DCM | Not Soluble | Soluble | Not Soluble | Not Soluble | Soluble |
| CHCl₃ | Not Soluble | Soluble | Not Soluble | Not Soluble | Not Soluble |
| Ethyl acetate | Not Soluble | Soluble | Not Soluble | Not Soluble | Soluble |

Preparation of polymer solutions. Nafion Solution includes 20 ml of water added to 5 grams of nafion pellets in total 180 ml of ethanol (60 ml), methanol (60 ml), isopropanol (60 ml). The solution mixture was then heated to 40° C. and stirred using a magnetic stirrer. After the nafion pellets were fully dissolved in the short-chain alcohol/water mixture, the solution was evaporated until the total volume reached 100 mL. The final solution concentration was 5% (w/w).

Protonated Poly(sodium-4-styrene) sulfonate solution. Concentrated hydrochloric acid (30 grams) was added to the 20 grams of poly(sodium-4-styrene) sulfonic acid. The solution was stirred well and isopropyl alcohol (70 grams) was transferred to the mixture. The mixture was stirred well and placed under the hood overnight. The solution was filtered and an extra 30 grams of concentrated HCl+i-PrOH solution was added to the filter cake, stirred and allowed it to sit overnight. The mixture was filtered as before and filtrate was added to the first batch. The concentration of the solution was about 20% (w/w).

Polystyrene Solution in Chloroform. Polystyrene (10 grams) was weighed to a cleaned empty beaker and 50 ml of chloroform was added to the beaker. The solid polymer pellets completely dissolve in chloroform at room temperature. The concentration of the solution was 0.2 g/ml or 20% (w/v).

Polystyrene Solution in Ethyl Acetate. Polystyrene (5 grams) was weighed to a cleaned empty beaker and ethyl acetate was added to the same beaker until the total weight of material becomes 50 grams. The solid pellets completely dissolve in ethyl acetate at room temperature. The concentration of the solution was 10% (w/w).

Polyacrylate solution. Freshly prepared polyacrylate polymer (about 20 grams) was weighed into a clean empty beaker and ethyl acetate (about 80 grams) was added. The solid polymer dissolves completely in ethyl acetate affording a 20% (w/w) polyacrylate solution.

Preparation of sensor films. Oxygen sensing films can be prepared by two methods. The first method includes introducing the dye followed by the plasticizer into the polymer matrix. The second method includes introducing the plasticizer followed by the dye into the polymer. The composition of the dye, polymer and the plasticizer influence the properties of the polymer films. Four different polymers and plasticizers have been used to make the films with various results; however, the skilled artisan will recognize that other combinations may be used.

Plasticizers. Several different plasticizers have been examined for the polymer solutions and the best plasticizer for a particular application was selected by measuring the oxygen sensitivity for each polymer matrix. In order to improve the oxygen sensitivity of the sensor film the plasticizer should be soluble in the polymer matrix and the oxygen permeability of the sensor film should increase with addition of the plasticizer.^{46,54}

Procedure for Solubility of Plasticizers. Solubility of plasticizers was determined in polystyrene, protonated-polysodium-4-styrene sulfonate and newly synthesized polyacrylate solutions and results provided in Table 2. Solubility of each plasticizer was examined by adding one drop of each plasticizer into 1 ml of solvent/polymer mixture.

TABLE 2
Quantitative solubility of plasticizers in polymers.

| | Polstyrene | Protonated polystyrene | Polyacrylate |
|---|---|---|---|
| | (20% w/w in | (20% w/w in | (20% w/w in |
| Plasticizer | ethyl acetate) | i-PrOH) | ethyl acetate) |
| Dioctyl | Soluble | Soluble | Soluble |
| phthalate | | | |
| Diphenyl | Not Soluble | Not Soluble | Not Soluble |
| isophthalate | | | |
| p-Tolune | Soluble | Soluble | Soluble |
| sulfonic acid | | | |
| monohydrate | | | |
| Phthalic acid | Soluble | Soluble | Soluble |
| benzyl n-butyl | | | |
| ester | | | |
| Diphenyl | Not Soluble | Not Soluble | Not Soluble |
| phthalate | | | |
| p-styrene | Not Soluble | Soluble | Not Soluble |
| sulfonic acid | | | |
| Allylsulfonic | Not Soluble | Not Soluble | Not Soluble |
| acid sodium salt | | | |
| Vinylsulfonic | Not Soluble | Not Soluble | Not Soluble |
| acid sodium salt | | | |

### When the plasticizer was soluble, the mixture was clear and there was no phase separation in the polymer/plasticizer mixture.

Formulation and Order of Addition. The three main components of the polymer film must be added in a specific form to get the maximum oxygen sensitivity. Studies were carried out by changing the order of addition of polymer, ruthenium complex and the plasticizer to determine if the order of addition influences the sensor response. The data obtained indicated that the order of addition influences the sensor response. In order to get the maximum oxygen sensitivity, ruthenium was dissolved and incorporated into the polymer matrix first and then the plasticizer was introduced to the polymer-ruthenium mixture. The solution mixture was stirred well after addition of each new component.

Studies were carried out to optimize the relative concentration of each component in the oxygen sensor film. For the measurements, one component was adjusted while the other two were kept constant. The optimum concentration of the ruthenium complex, polymer and the plasticizer were obtained independently of the other variables and combined in the end to produce the optimized sensor.

The Preparation of Oxygen sensing film. A 20% polyacrylate polymer solution was made by dissolving 20 grams of freshly prepared solid polymer in 80 grams of ethyl acetate. To this solution [Ru(Ph₂Phen)₃](Cl₂) dissolved in dichloromethane (3 mg/mL wt/v) was added such that the ratio of Ru complex versus polymer was 0.005 grams Ru to 1 grams of polymer. The solution was stirred mechanically, to incorporate the Ru complex in the polymer solution. Finally, dioctylphthalate was added to the solution such that the ratio of plasticizer versus polymer was about 0.50 grams dioctylphthalate per about 1.0 grams of polymer/Ru/plasticizer.

The sensor material was cured for about 24 hours at about 60° C. in a vacuum oven. The resulting material was transformed from an opaque orange to translucent orange during the heating. With heating, the dye is more fully saturated in the polymer matrix resulting in a higher distribution. Prior to curing the deposition method strongly influenced the sensor response. However, the reconstituted material shows no dependence on the deposition method.

The freshly prepared sensor solution was either, spin coated, wipe coated, or pipetted as a dot on a glass slide and allowed to dry under ambient conditions overnight. The lifetime measurements were performed on the film after about 24 hours of deposition and within about 48 hours of preparation using the device of the present invention.⁵³

Characterization of Sensor film. Fluorescence Spectroscopic Characterization. Fluorescence spectroscopy is used to determine the emission wavelength and intensity of the excited ruthenium(II) metal-to-ligand transfer band, due to embedded ruthenium(II)polypyridyl complex in the sensor film. The PerkinElmer LS55 Luminescence spectrometer was used to make measurements. Each sensor film was scanned at a speed of 1200 nm/min and the slit width of excitation and emission was 10 nm. All measurements were carried out under room temperature.

TABLE 3
Fluorescence Characterization of sensor films

| | Excitation | Emission |
|---|---|---|
| Polymer Film | Wavelength (nm) | Wavelength (nm) |
| Nafion | 460 | 600 |
| Polystyrene | 470 | 600 |
| Protonated polystyrene | 470 | 620 |
| sulfonate | | |
| Polyacrylate | 470 | 610 |

Fluorescence quenching study.⁵² Oxygen quenching of the fluorescence was studied using the non-invasive oxygen analyzer system of the present invention. The non-invasive oxygen analyzer system of the present invention is a novel optical measurement device and method for determining the oxygen contaminant within sealed packages. It measured oxygen gas within the package headspace or dissolved in the liquid with the oxygen concentration obtained directly, reliably and repeatably without destroying the integrity of the package seal. This instrument has been used to measure oxygen content of a package using the fluorescence lifetime quenching principle. The sensor film can be manually attached to the inside of a package or pre-fabricated into the barrier coating of the package material. The sensor was illuminated by blue LED (about 470 nm) of about 1 μs pulses at a frequency of 20 kHz. During every measurement, a single 50 μs pulse of the fluorescent signal was recorded in the computer and 1000 pulses were averaged to calculate the time constant (T_{C}).

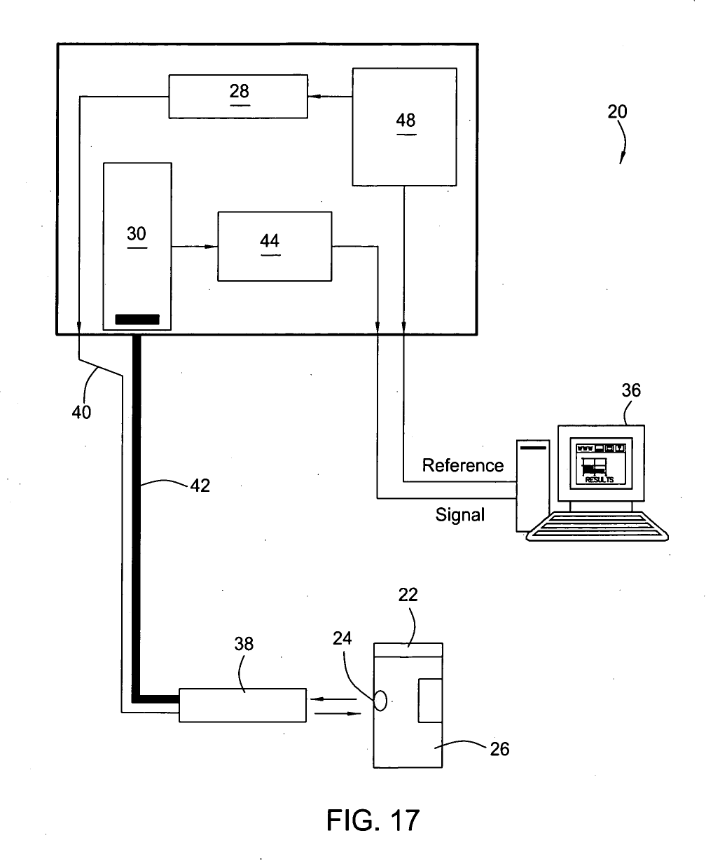

FIG. 17 is a schematic that illustrates one embodiment of the present invention. The oxygen sensitive luminescence indicator reading device 20 of the present invention that includes the excitation from the emission source 28 is brought to the luminescence indicator 24 by a scanner device 38 through the excitation lead 38 or other light conducting device. The luminescence indicator 24 is positioned within the enclosure 22 and in contact with the internal environment 26. The emission from the luminescence indicator 24 is brought to the detector 30 using emission lead 40 connected to the scanner device 38. The oxygen sensitive luminescence indicator reading device 20 may be connected to a computer 36 or CPU. In addition, the oxygen sensitive luminescence indicator reading device 20 may be include an amplifier 44 connecting between the detector 30 and the computer 36 or CPU and/or a pulse generator 48 connecting the emission source 28 to the computer 36 or CPU. The fluorescence decay time is measured using the electronics in the instrument and this related to the oxygen concentration using the Stern-Volmer equations.

As an example, four different polymer matrices including nafion, polystyrene, protonated polystyrene sulfonate and heterogeneous polyacrylate were used to prepare sensor films. These polymers were selected after carefully evaluating literature on oxygen sensing materials.⁵⁵⁻⁶¹ Each sensor film is unique due to differences in the polymer matrix and are in no way meant to limit the present invention. The polymer matrix serves as a support for the dye and also as a medium for oxygen transport from the atmosphere. The present invention may use a variety of different combination of to achieve the desired results. For example the effectiveness of the oxygen sensor may be altered by a variety of approaches including selecting a dye with long or short unquenched excited state lifetimes (τ₀), polymers with high or low oxygen permeabilities and polymer-dye combinations in which the dye dissolves directly in to the polymer.

One example of the present invention includes a positively charged ruthenium(II)polypyridyl complex immobilized in a polymer matrix. Generally, the ruthenium complex exists in +2 oxidation state allowing anionic polymers to provide electrostatic binding sites for the dye molecules. A variety of approaches were taken to improve the characteristics of the oxygen sensor films. Addition of plasticizers into the polymer/ruthenium mixture improves the oxygen quenching of the fluorescence lifetime by preventing dye aggregation and increases the oxygen permeability in the polymer matrix. Additionally, the present invention may be optimized for an individual purpose by optimizing the individual components of the sensor film, including polymer composition, ruthenium concentration and plasticizer concentration. For example, the oxygen sensing dye, tris(4,7-diphenyl-1,10-phenanthroline)dichloride⁶² was used in one embodiment of the present invention. The choice of plasticizer used in each polymer matrix was based on the polymer chosen.

Nafion, a perfluorinated, thermally stable, chemically and biologically inert polymer, may be used in the present invention. The charge properties of the polymer make it an interesting polymer for producing an oxygen sensor because of electrostatic interactions between the polymer and charged ruthenium(II) dye. Polystyrene is a neutral polymer and may be used to prepare variety of sensors of the present invention. Protonated polystyrene sulfonate is an acidic polystyrene derivative, which has an electrostatic interactions with the positively charged ruthenium(II)polypyridyl complex and the negatively charged polymer matrix. These electrostatic interactions were viewed as favorable to prevent leaching of the dye from the sensor film; however, other polymers may be used to form the sensors of the present invention. For example, a heterogeneous polyacrylate polymer, was synthesized based on high oxygen permeation observed previously for the material.

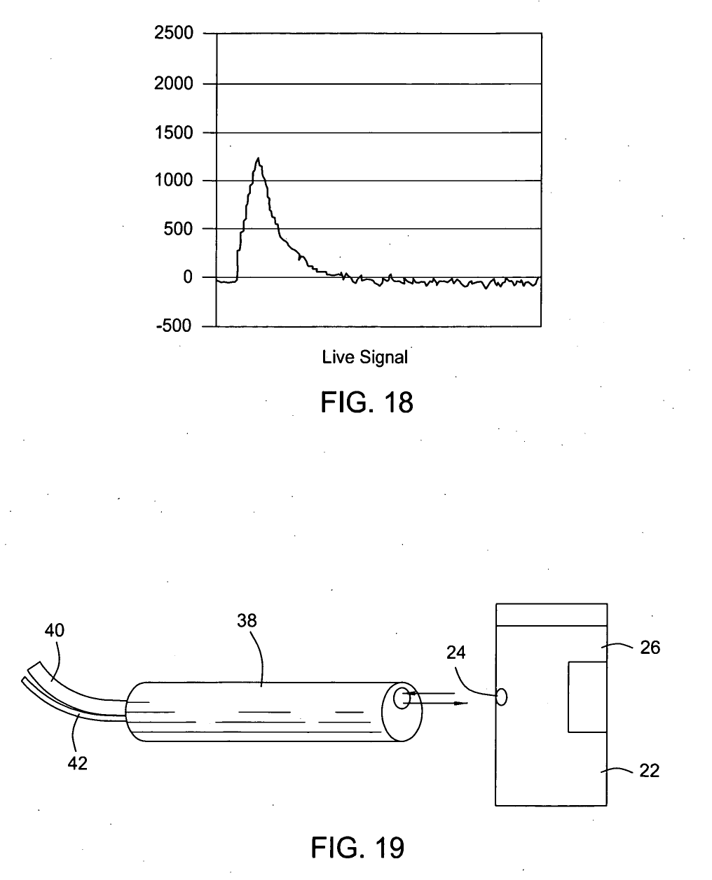

The typical fluorescent sensor utilizes changes in the fluorescent intensity in the presence of the quencher oxygen. Typically, measurements focus on the change in lifetime decay in the form of the time constant (T_{C}). T_{C} is the term using for the data analysis, which represents the life time τ in the Stern-Volmer equation. The relationship between the Stern-Volmer equation and the T_{C} will be given in equation 3(e) and 6(a). The non-invasive oxygen analyzer system of the present invention was used to measure the lifetimes of the sensor materials. FIG. 18 shows the fluorescence lifetime signal in ambient air as appeared on the main screen of the instrument of the present invention, where x axis gives time in μs and y axis gives the relative intensity.

The time constant (T_{C}) is the time required for the fluorescence decay of the chromophore. Time constants (T_{C}) were measured using a nitrogen atmosphere for 0% oxygen (τ₀) and compressed air with 20% oxygen (τ). ΔT_{C} is the difference between time constants (τ₀−τ), when measurements were taken in 0% oxygen and 20% oxygen.

One of the advantages of using lifetime over intensity is the measurements do not vary with a shift wavelength of emission of the chromophore commonly associated with quenching of fluorescence intensity. Lifetime measurements are typically more sensitive than intensity with respect to oxygen quenching also an advantage of using the fluorescence lifetime. There are several factors that influence the T_{C} and intensity of the fluorescence. The relationship between the T_{C} and intensity will be given in equation 1(a).

T_{C}=τ₀/(Iₒ/I) 1(a)

Where I is the emission intensity in the presence of oxygen, Iₒ is the emission intensity in the absence of oxygen, T_{C} is the luminescence lifetime in the presence of oxygen, τ0 is the luminescence lifetime in the absence of quencher oxygen.

One important factor that influences the fluorescence lifetime and intensity are dye aggregation.⁶⁴ When the dye concentration increases, the dye molecules aggregate with each other with resulting difficulty for the quencher oxygen molecules to penetrate to each dye molecule. As a result, the intensity observed will be higher and lifetime is longer than expected and the ΔT_{C} value is lower than expected.

FIG. 19 is a schematic diagram of measuring the oxygen content in sealed package using the present invention. As shown, the present invention includes an analyzer reader pen to get measurements from the oxygen sensing dye from the opposite direction of where oxygen penetrates to the sensing dot. The sensor surface, which is exposed to the LED light, is the least oxygen-quenching area.

The oxygen sensitive luminescence indicator reading device 20 of the present invention that includes the excitation from the emission source (not shown) is brought to the luminescence indicator 24 by a scanner device 38 through the excitation lead 38 or other light conducting device. The luminescence indicator 24 is positioned within the enclosure 22 and in contact with the internal environment 26. The emission from the luminescence indicator 24 is brought to the detector (not shown) using emission lead 40 connected to the scanner device 38. The oxygen sensitive luminescence indicator reading device 20 may be connected to a computer (not shown). Therefore, optical density is also an important factor that influences the T_{C} values of the sensor film. When the polymer concentration is high, it is difficult for the oxygen to quench the fluorescence; the fluorescence intensity and lifetime increase because oxygen cannot quench the fluorescence as the ΔT_{C} value is lower than expected. Self quenching of chromophores are also a factor that influence the T_{C} values of the sensor films. When the dye concentration is high, proximity interactions and internal quenching of chromophores may occur and can lead to lower ΔT_{C} values. The oxygen permeability of the sensor film is another factor that influences the T_{C} data. Introducing plasticizer into the sensor system can improve the oxygen permeability.⁶⁵⁻⁶⁶ When the oxygen permeability is high, the fluorescence intensity and lifetime decreases and results in higher ΔTC values.

Nafion polymer oxygen sensor. Nafion is one polymer used in the present invention as a result of its high thermal stability (up to 200° C.), mechanical strength and chemical and biological inertness.⁵⁵ In addition, nafion is a conductive polymer which can be used in both optical and electrochemical sensing regimes in other embodiments of the present invention.

In one preparation, two different ruthenium complexes were used; a commercially available [Ru(Ph₂Phen)₃](Cl)₂ complex and a synthesized [Ru(Ph₂Phen)₃](PF₆)₂ complex. The ruthenium complex was synthesized in the laboratory in order to reduce the cost for the oxygen sensor system. Ruthenium solution was made by dissolving each one of these complexes in dichloromethane to obtain the final concentration of 3 mg/ml. 100 μl of each of these solutions were transferred to the 2 ml of nafion solution. The solution mixture was stirred well and aliquots of 3 μl were placed as dots on glass slides and dried overnight.

Four different samples were made. Sample 1 and 2 were prepared with the commercially available [Ru(Ph₂Phen)₃](Cl)₂ complex. For sample 1, a 3 μl aliquot was placed onto a glass slide and dried. Alternatively, for sample 2 three 1 μl aliquots were added sequentially after each was allowed to dry. In both cases, a total of 3 μl of material was used for each dot. Sample 3 and 4 were made in the same manner using the synthesized [Ru(Ph₂Phen)₃](PF₆)₂ complex.

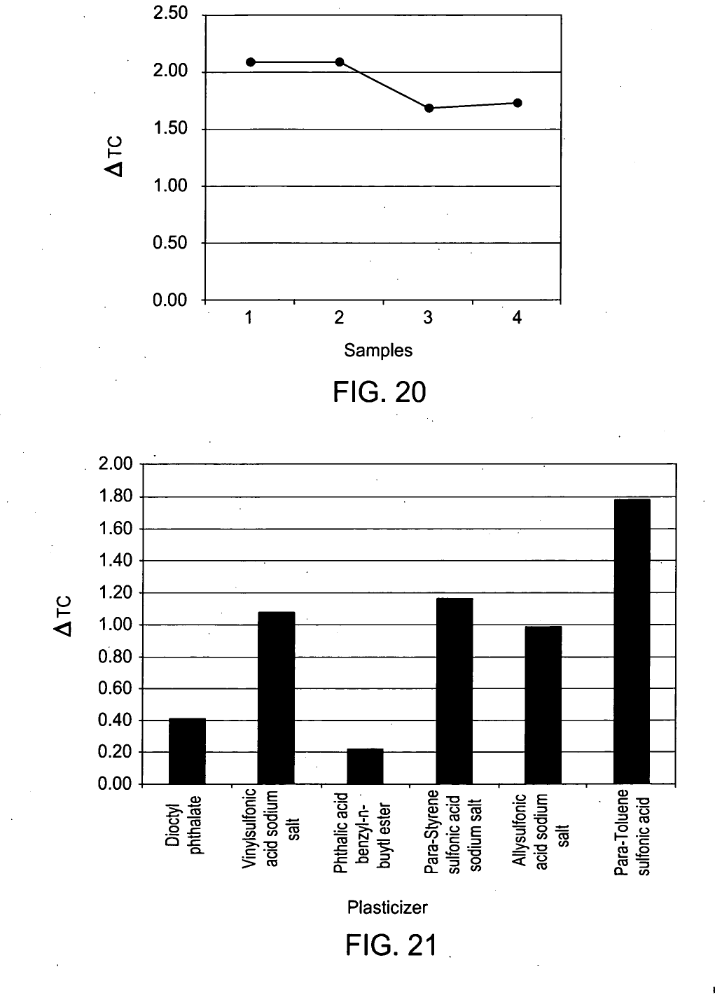

FIG. 20 is a graph of the lifetimes of the Nafion polymer samples 1-4 having a concentration of 0.00015 Ru (gram)/Polymer (gram). The oxygen sensor films made up of [Ru(Ph₂Phen)₃](Cl)₂ complex give a ΔT_{C} value of 2.08 and [Ru(Ph₂Phen)₃](PF₆)₂ complex gives ΔT_{C} value of 1.7. These results indicate that the counter ion may play a role in oxygen sensitivity. However, the PF₆⁻ is larger than Cl⁻ ion, which could influence the oxygen permeability, reducing the oxygen quenching and lowering ΔT_{C}. The oxygen quenching lifetime studies proved (ΔT_{C}=2.08) that nafion is an acceptable candidate for the oxygen sensor material.

Polystyrene polymer oxygen sensors. Polystyrene is a well known neutral polymer that has been used in variety of sensor applications and may be dissolved in two different solvents, chloroform and ethyl acetate.⁵⁸⁻⁶⁰ For example, a 10% polymer solution was added to a vial followed by a 0.01 Ru(grams)/Polymer (grams) of [Ru(Ph₂Phen)₃](Cl)₂ solution and the plasticizer concentration of 25% plasticizer (grams)/Polymer (grams). Several plasticizers were added to the polymer-ruthenium matrix. The plasticizer that provided the highest ΔT_{C} value was chosen from the series.

FIG. 21 is a graph of the plasticizer incorporated into the ruthenium-polystyrene mixture dissolved in ethyl acetate. In both solvent systems, the best plasticizer for the polystyrene was para-toluene sulfonic acid. The polymer dissolved in ethyl acetate gave higher ΔT_{C} values than the polymer dissolved in chloroform.

The role of the ruthenium dye concentration in a 10% polymer solution was also studied. The amount of plasticizer used was 25% w/w compared to the polymer. We first started with an average percentage of polymers, dye and plasticizer based on published values in the literature.⁵⁸⁻⁶⁰ Plasticizer that did not dissolve in the ruthenium-polymer mixture was dissolved in an appropriate solvent and added it to the ruthenium-polymer mixture. For example, polystyrene and para-toluene sulfonic acid was soluble in the solvent mixture and it was not necessary to dissolve it prior to addition to the polymer-ruthenium mixture. The sensor film mixture was then spin coated on the glass slides at a rate of 1000 rpm for 30 seconds. Spin coated samples were placed under the fume hood to dry overnight and lifetime data was taken after drying. Spin coating is but one method used to deposit the sample.

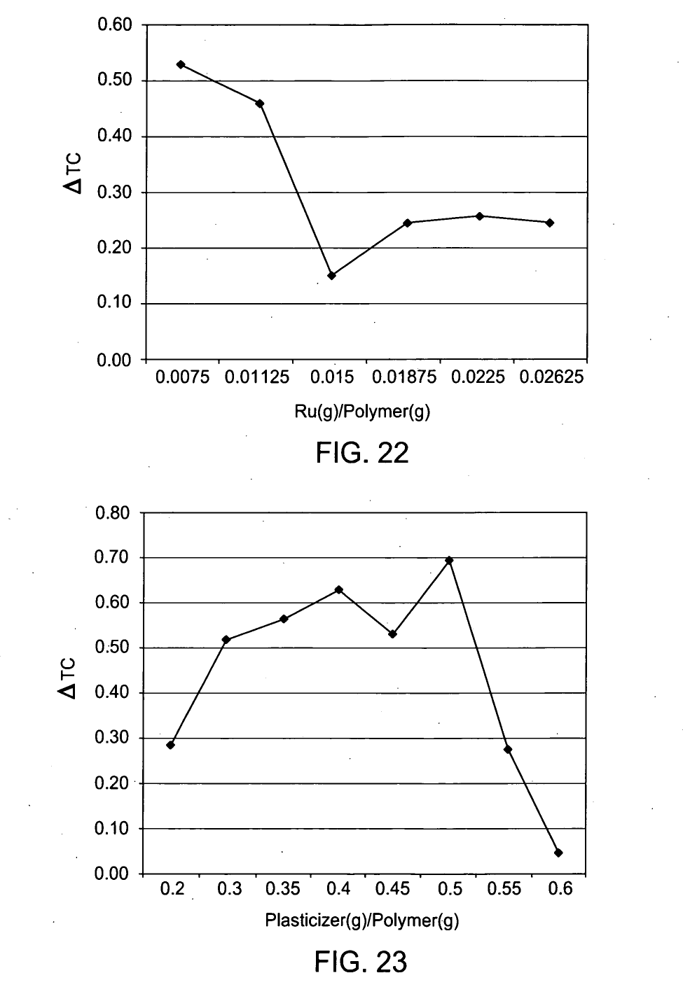

FIG. 22 is a graph that illustrates ΔT_{C} data for changing ruthenium concentration in polystyrene. The polystyrene was dissolved in ethyl acetate and para-toluene sulfonic acid was used as the plasticizer. The ruthenium concentration study shows that ΔTC values decreases when ruthenium concentration increases from about 0.0075 to about 0.015 Ru (grams)/Polymer (grams). After about 0.015 Ru (grams)/Polymer (grams), ΔT_{C} values become constant indicating that at lower ruthenium concentration ΔT_{C} is higher. Suggesting that lower ΔT_{C} at higher ruthenium concentration may be due to dye aggregation and self quenching of chromophores. When the chromophores are not internally quenched by each other, ΔT_{C} is increases, at higher ruthenium concentrations the ΔT_{C} values become constant due to proximity interactions and quenching of the chromophores. In one embodiment, the ruthenium concentration for the polystyrene system is about 0.0075 Ru (grams)/Polymer(grams).

FIG. 23 is a graph of the lifetime data obtained for polystyrene dissolved in ethyl acetate with 0.0025 Ru (g)/Polymer(g) concentration with various plasticizer concentrations. The ΔT_{C} values increase with increase of plasticizer concentration ranges from about 0.2 to about 0.5 plasticizer (grams)/polymer (grams). After about 0.5 plasticizer (grams)/polymer (grams) concentration, the ΔT_{C} value decreases with increasing plasticizer concentration. The average plasticizer amount for the ΔT_{C} is about 0.5 plasticizer (grams)/polymer (grams) based on the data.

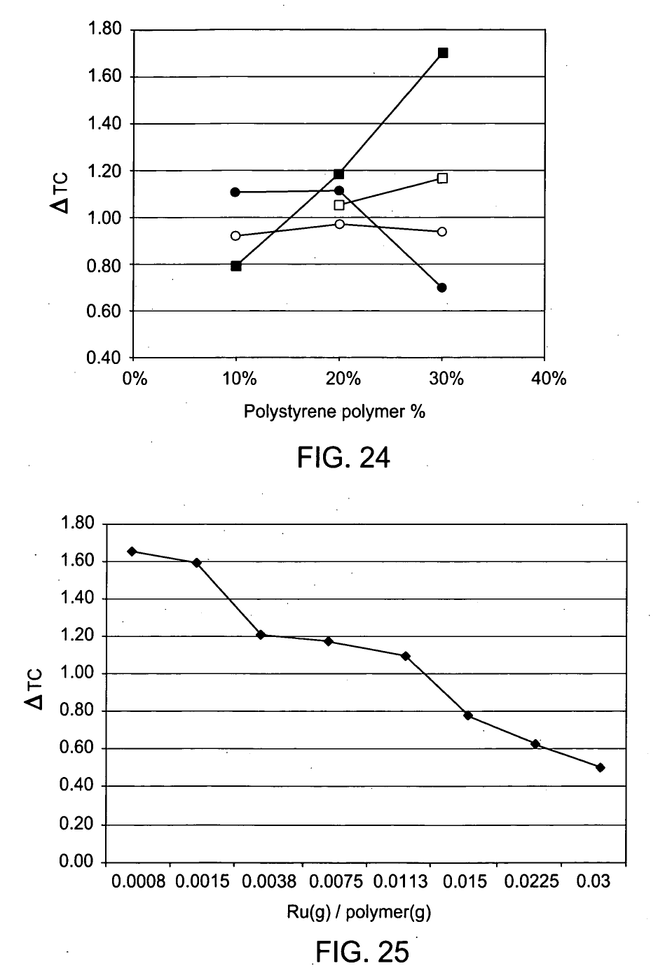

FIG. 24 shows the ΔT_{C} data for changing polymer concentration. In this study polymer was dissolved in dichloromethane as well as ethyl acetate. The results were obtained using ruthenium concentration of about 0.01 Ru (grams)/Polymer (grams) and the plasticizer concentration of about 0.5 plasticizer (grams)/polymer (grams). FIG. 24 is a graph of ΔT_{C} values obtained for the polystyrene polymer concentration, polystyrene dissolved in ethyl acetate (□) in spread series, (▪) drop series, and dichloromethane spread (◯) and drop () series. The polystyrene polymer study shows that Ethyl acetate is a better solvent to prepare sensor material over dichloromethane. In ethyl acetate series, the ΔT_{C} values increases with increase in polymer concentration. Therefore, the optimized conditions for polystyrene polymer, where ΔTC value of about 2.0 is, about 30% polymer, about 0.5 plasticizer (grams)/polymer (grams) and about 0.01 Ru (grams)/Polymer (grams) [Ru(Ph₂Phen)₃](Cl)₂ concentration in ethyl acetate solvent system.

Polystyrene sulfonate polymer oxygen sensor. Protonated polystyrene sulfonate was prepared using polystyrene sulfonic acid sodium salt. Poly(sodium-4-styrene)sulfonate is an anionic polymer⁵⁶ which is interesting because of the electrostatic interactions with the positively charged ruthenium complexes. These electrostatic interactions can prevent leaching of the dye.

In addition, the order of addition of components may be varied to optimize the conditions. For example, the order of addition of each component for the protonated polystyrene sulfonate is different than the nafion and polystyrene systems. [Ru(Ph₂Phen)₃](Cl)₂ powder was dissolved in isopropanol. Then polymer dissolved in isopropanol was transferred to the ruthenium solution and mixed well. Para-toluene sulfonic acid was dissolved in isopropanol and added last to the polymer/ruthenium mixture. This plasticizer was chosen using the same protocol used for polystyrene. The solution was stirred well and spin coated at a rate of 1000 rpm for 30 seconds. Film samples were dried overnight under the fume hood and measured.

FIG. 25 is a graph that illustrates the optimization three components carried out with an initial solution of 20% protonated polystyrene sulfonate acid, 25% plasticizer and the ruthenium concentration was varied from about 0.008 to about 0.03 Ru (grams)/Polymer (grams). These films show maximum ΔT_{C} values at the lower ruthenium concentrations suggesting that the optimum may be at much lower concentration than about 0.0008 Ru (grams)/Polymer (grams). Therefore, the optimum concentration used in this embodiment was about 0.0008 Ru (grams)/Polymer (grams). The ΔT_{C} value decreases with increase of ruthenium concentration and is an indication of dye aggregation, a decrease of optical density, and self quenching of chromophores.⁶⁴

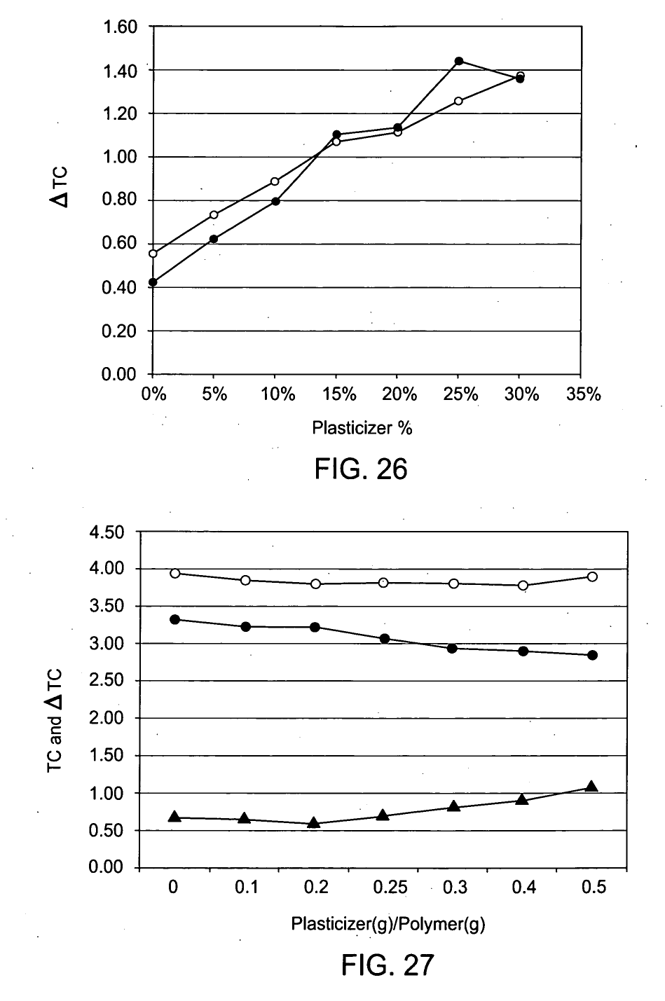

FIG. 26 is a graph of the optimization of the plasticizer carried out using two different concentrations of ruthenium complex. The amount of plasticizer added to each film was varied from about 0 to about 0.35 plasticizer (grams)/polymer (grams) as displayed in. Plasticizer concentration of protonated polystyrene sulfonate polymer system using about 20% (w/w) polymer concentration, about 0.0005 Ru (grams)/Polymer (grams) (◯) and 0.001 Ru (grams)/Polymer (grams) () show that the ΔTC values increases with the increase of plasticizer concentration. As seen in the previous polymer systems, ΔTC value increase with the increase of plasticizer concentration. The explanation for this type of relationship is by adding plasticizer to the system, the oxygen permeability of sensor film increases.⁶⁵⁻⁶⁶ Oxygen quenches the fluorescence lifetime, and as a result ΔT_{C} increases. The ΔT_{C} had not reached a constant value indicated the optimum concentration of plasticizer is greater than about 0.35 plasticizer (grams)/polymer (grams). The plasticizer concentration could not exceed the about 35% limit as the sensor mixture separates due to miscibility problems with the polymer matrix. In addition, the protonated polystyrene sulfonate polymer system did not provide ΔT_{C} values above a ΔT_{C}=2.0 at any ruthenium or plasticizer concentration. Therefore a heterogeneous polyacrylate polymer was used.

Polyacrylate polymer oxygen sensors. Generally, the polyacrylate polymer is a heterogeneous material made up of four different monomer units. The heterogeneity of the polymer matrix results in high oxygen permeability⁷ which can provide enhanced oxygen quenching of fluorescence lifetime resulting in higher ΔT_{C} values. Polyacrylate is soluble in both dichloromethane and ethyl acetate solvents. Therefore sensor films were prepared using both solvent systems to find out which solvent gives higher ΔT_{C} values.

One plasticizer for the polyacrylate system is dioctylphthalate. To prepare the sensor [Ru(Ph₂Phen)₃](Cl)₂ was dissolved in dichloromethane and added to the polymer solution and mixed. Addition of the plasticizer dioctylphthalate completed the solution preparation. Plasticizer concentration was studied using two different polymer concentrations. The ruthenium concentration for both 10% and 30% polymer solutions was about 0.0015 Ru (grams)/Polymer (grams). In these embodiments, the sensor films were spin coated on glass slides at a rate of 1000 rpm for 30 seconds.

FIG. 27 is a graph that shows the T_{C} and ΔT_{C} data for changing plasticizer concentration in 10% polyacrylate. T_{C} in the presence of oxygen (), in the absence of oxygen (◯) and ΔT_{C} (▴) values for the plasticizer concentration study using 10% polyacrylate polymer concentration.

When plasticizer concentration increases, there is a very little change in ΔT_{C} between about 0 to about 0.2 plasticizer (grams)/polymer (grams). After about 0.2 plasticizer (grams)/polymer (grams), ΔT_{C} increases rapidly with increase of plasticizer concentration. In one embodiment, the 10% polymer system the plasticizer concentration is kept at about 0.5 plasticizer (grams)/polymer (grams).

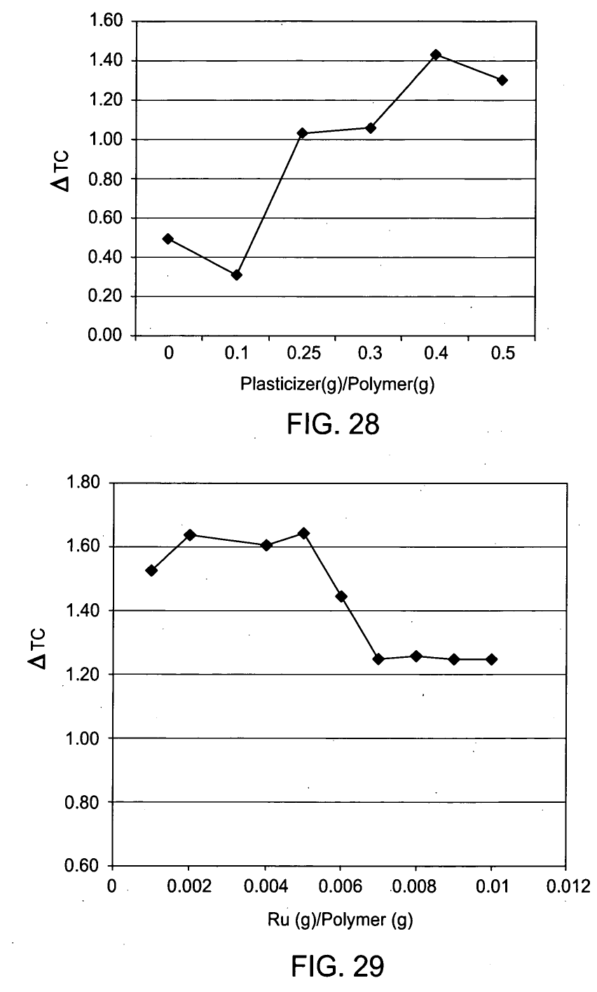

FIG. 28 is a graph of the ΔT_{C} values with a plasticizer study of about 30% polyacrylate and about 0.0015 Ru (grams)/Polymer (grams) concentration. At 30% polymer concentration, the ΔT_{C} value increases with increase of plasticizer concentration consistent with the 10% polymer. The difference between the two systems is the ΔT_{C} values obtained for the 30% polymer systems are much larger than the 10% polymer system; however, neither exceeds the ΔT_{C}=2.0 threshold at this point.

FIG. 29 is a graph that shows the ΔT_{C} data for changing ruthenium concentration in 10% polyacrylate polymer solutions with about 0.25 plasticizer (grams)/polymer (grams). Polymer films made of about 10% polyacrylate show ΔT_{C} values when the ruthenium concentration ranges from about 0.002 to about 0.005 ruthenium (grams)/polymer (grams). When the ruthenium concentration increases above about 0.005 ruthenium (grams)/polymer (grams), the ΔT_{C} value decreases, and the ΔT_{C} values become constant at about 0.008 ruthenium (grams)/polymer (grams). These results indicate that at higher ruthenium concentration dye aggregation takes place and the oxygen quenching of fluorescence lifetime reaches a constant value as ruthenium concentration continuous to increase.

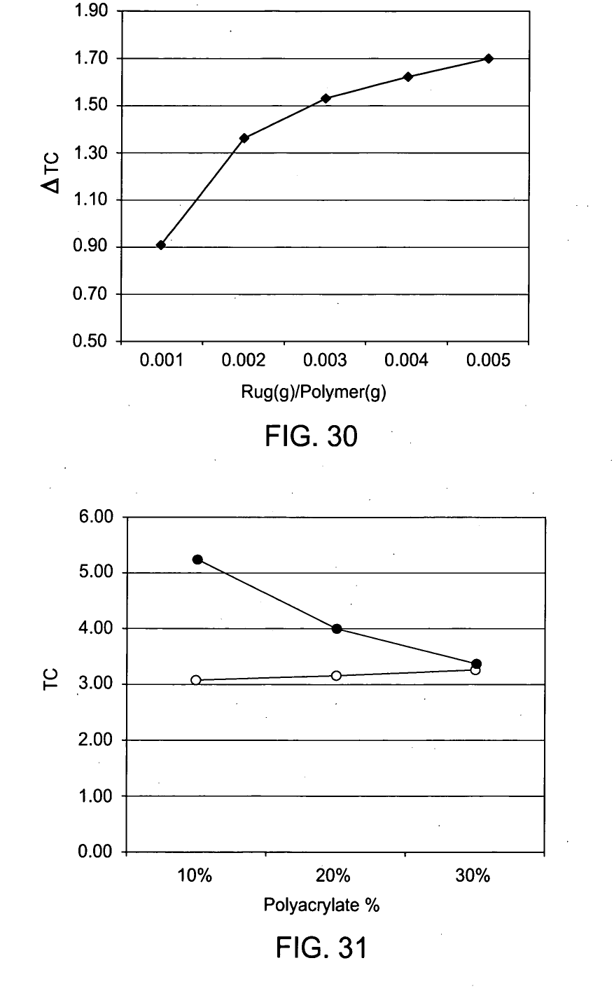

FIGS. 30-38 are graphs that illustrate different methods of preparing films including spin coated, dip coated and wiped sensor films. Ruthenium concentration used were about 0.005 ruthenium (grams)/Polymer (grams) and the plasticizer concentration was about 0.5 plasticizer (grams)/polymer (grams). FIG. 30 is a graph of that shows the ΔT_{C} data for changing ruthenium concentration in about 30% polyacrylate polymer solutions. The results obtained for the 30% polyacrylate shows ΔT_{C} increases with increase of ruthenium concentration, but the rate of increase of ΔT_{C} decreases with increase of ruthenium concentration. The optimum concentration of ruthenium is about 0.005 ruthenium (grams)/polymer (grams) when the polyacrylate concentration is 30%; however, other concentrations of ruthenium and polymer may be used. In some embodiments, the polymer concentration of 10% or 30% showed optimum ruthenium concentration of about 0.005 ruthenium (grams)/polymer (grams).

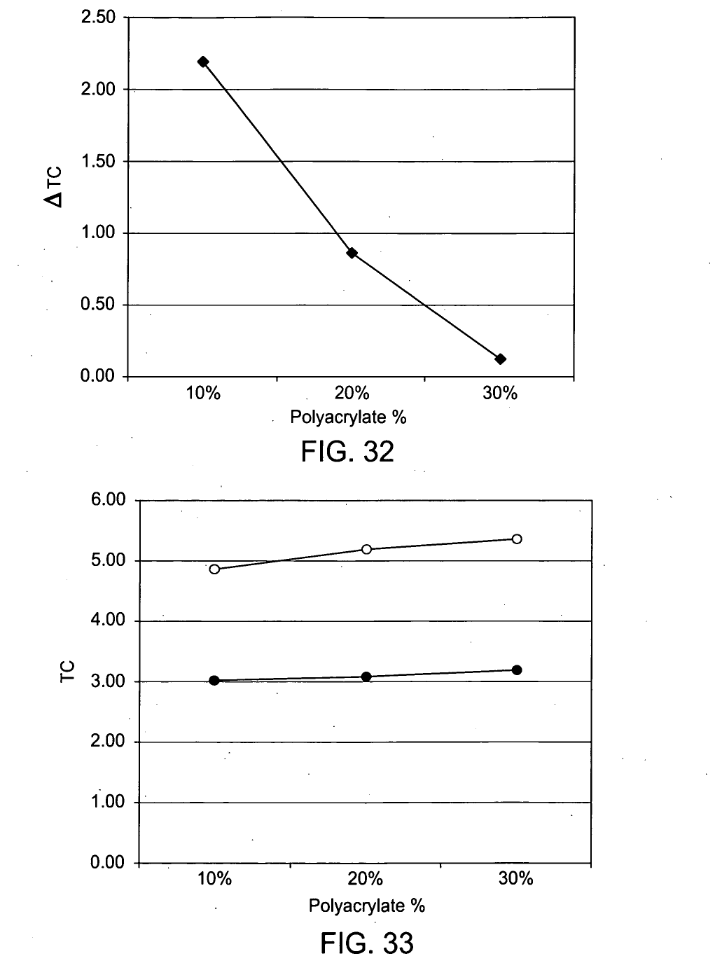

FIGS. 31 and 32 are graphs that show T_{C} and ΔT_{C} values obtained for 10%, 20% and 30% polymer concentrations for polymer dissolved in dichloromethane. The ΔT_{C} value decreases with increase of polymer concentration. When the polymer concentration is 10%, the ΔT_{C} values were above 2.0. FIG. 31 is a graph of polymer concentrations in the presence of oxygen () and in the absence of oxygen (◯) where polyacrylate dissolved in dichloromethane drop series. FIG. 32 is a graph of ΔT_{C} values for the polymer concentration of polyacrylate dissolved in dichloromethane drop series.

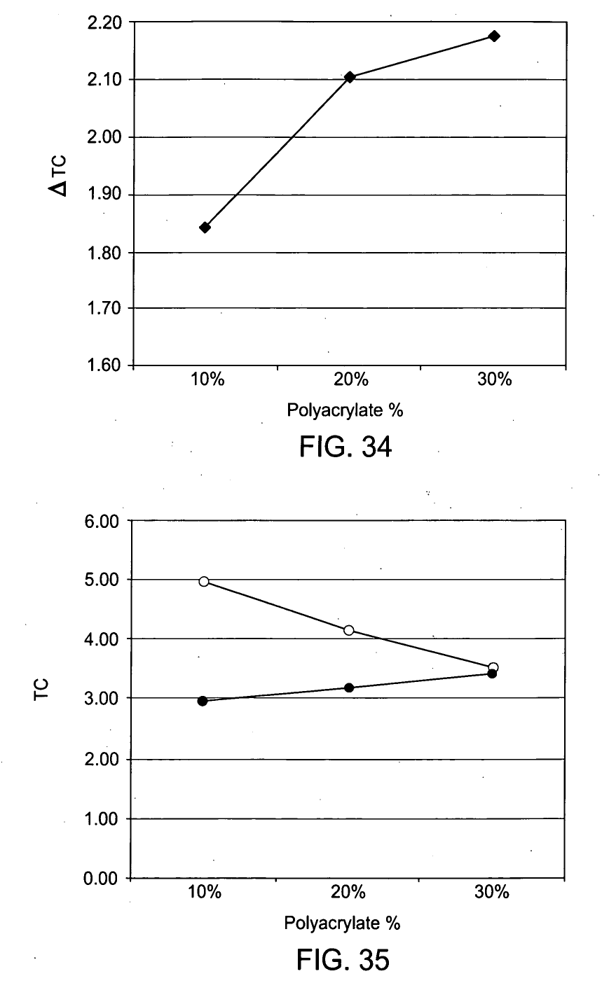

FIGS. 33 and 34 are graphs that show T_{C} and ΔT_{C} values obtained for 10%, 20% and 30% polymer concentrations, where polymer was dissolved in dichloromethane and series of spread samples showed an increase in ΔT_{C} value with an increase of polymer concentration. FIG. 33 is a graph that illustrates T_{C} values in the presence of oxygen () and in the absence of oxygen (◯), polyacrylate dissolved in dichloromethane spread series. FIG. 34 is a graph that illustrates ΔT_{C} values for the polymer concentration study of polyacrylate dissolved in dichloromethane spread series. When the polymer concentrations are 20% and 30%, the ΔT_{C} value reached above 2.0.

When the polyacrylate polymer dissolved in dichloromethane solvent, the drop series and spread series shows the trend of ΔT_{C} values go in opposite directions suggesting that optical density or dye aggregation dominates at higher polymer concentration in that solvent. With high film thickness, oxygen permeability⁶⁵ of the sensor film decreases, as a result ΔT_{C} values decrease with increase of polymer concentration. The drop and spread series illustrated the ΔT_{C} values are above 2.0, indicating that the system can be use to develop the oxygen sensor.

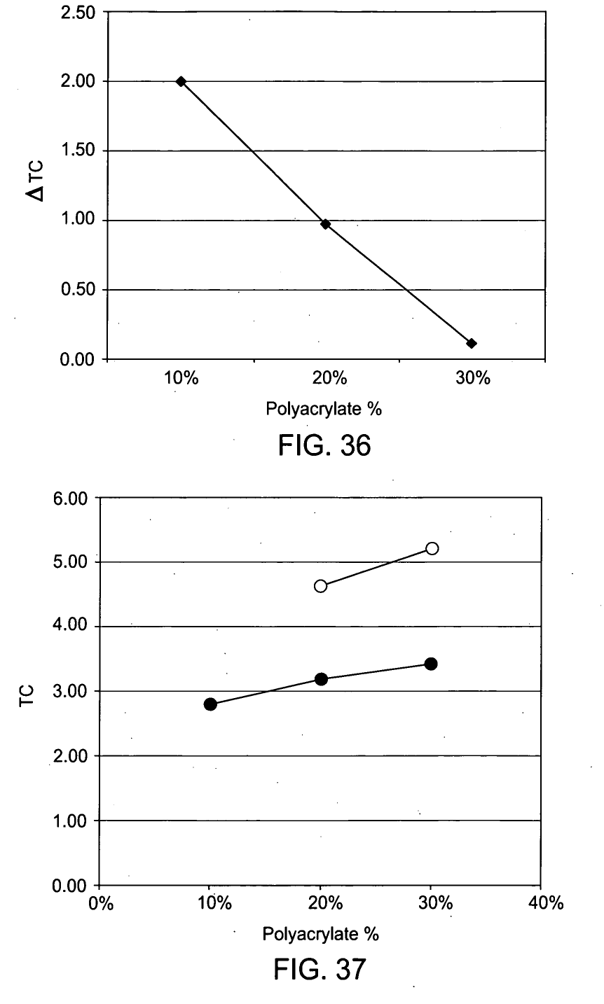

FIGS. 35 and 36 are graphs that illustrate the T_{C} and ΔT_{C} values for the polymer concentration of polyacrylate polymer dissolved in ethyl acetate where series of samples were placed as drops. FIG. 35 illustrates T_{C} values in the presence of oxygen () and in the absence of oxygen (◯), polyacrylate dissolved in ethyl acetate drop series. FIG. 36 is a graph of ΔT_{C} values for the polymer concentration study of polyacrylate dissolved in ethyl acetate drop series.

FIG. 37 is a graph that shows the T_{C} values obtained for polymer concentration study where polyacrylate was dissolved in ethyl acetate and samples were made by spreading the sensor solution. The T_{C} values in the presence of oxygen () and in the absence of oxygen (◯), polyacrylate dissolved in ethyl acetate spread series. The T_{C} values were obtained under nitrogen atmosphere, where polyacrylate dissolved in ethyl acetate spread series, at 10% polymer solution the signal was not strong enough to measure.

Polyacrylate dissolved in ethyl acetate spread series shows the same trend as for the dichloromethane spread series. When comparing the drop series with the spread series, the trend of ΔT_{C} values go in opposite directions. In the drop series, ΔT_{C} values decreases with increase of polymer concentration. In the spread series ΔT_{C} values increase with the increase of polymer concentration. These results suggest that dye aggregation¹⁰ plays a role in developing the sensor and that the thickness of the films and dye solubility are important factors in the sensor response.

Curing of sensor material was tested to find out if it can eliminate the ΔT_{C} dependence on the application method. Previous studies show that ΔT_{C} depend on the application method. When the sensor material was cured for 24 hours at 60° C., the material changed from opaque orange to translucent red-orange, indicating the dye interaction with the polymer matrix has changed. The transition indicates that the dye solubility has increased. As a result of curing (e.g., heat) the three component system mixed and distributed each component evenly. With this treatment the method used to cast the sensor films does not influence the response of the sensor. Prior to curing, the deposition method strongly influences the ΔT_{C} values.

In one embodiment, the ruthenium concentration was based on a dye/polymer ratio of about 0.005 and a plasticizer/polymer ratio of about 0.5. A 10% polymer solution was used and the three components were mixed in the order of polymer/dye/plasticizer. After mixing the three components, the sensor solution was cured for minimum of 24 hours at 60° C. to produce the final cured material. In the cured material, all solvent was removed under vacuum conditions to facilitate the complete drying of the material. The dried material was reconstituted in using about 0.1 gram per ml of solvent ethyl acetate and deposited on glass slides using different techniques. T_{C} and ΔT_{C} values were measured for the prepared samples.

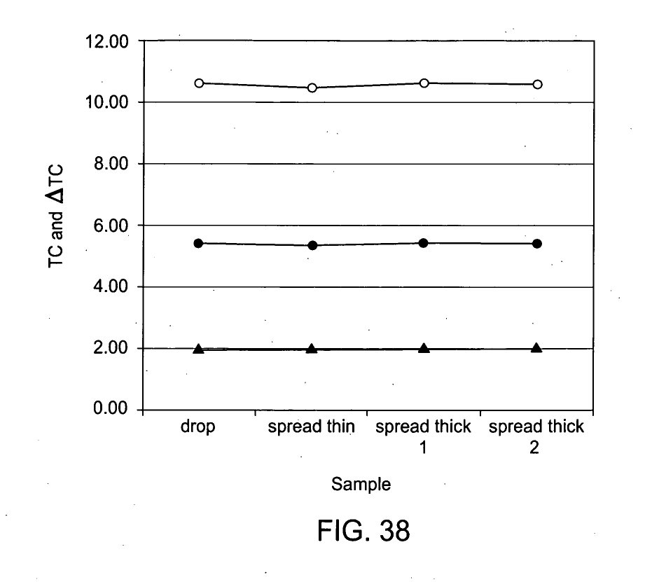

FIG. 38 is a graph that illustrates the T_{C} and ΔT_{C} values obtained for the reconstituted materials. T_{C} values in the presence of oxygen () and in the absence of oxygen (◯) and ΔT_{C} (▴) values for the reconstituted polyacrylate dissolved in ethyl acetate, optimized for all three components. FIG. 38 illustrates that all four samples reach the goal of ΔT_{C}=2.0 value.

When comparing all four polymers (e.g., nafion, polystyrene, protonated polystyrene sulfonate and polyacrylate), the best results were obtained with the cured polyacrylate polymer. In addition, some embodiments of the present invention have produced ΔT_{C} values over 2.0 for well over a year.

The present invention includes an optical oxygen sensing device and optical oxygen sensor for the food packaging industry where a non-invasive oxygen analyzer system can be used to measure the oxygen contaminant within sealed packages. Ruthenium(II)polypyridyl complexes are well-known oxygen sensing materials that have been used previously in sensor applications.⁶⁷⁻⁷⁶ When developing the sensor, these oxygen sensitive dyes were added to the polymer solution and plasticizer was added to improve the oxygen permeability of the sensor film. The present invention also provides a synthesize ruthenium complexes for the oxygen sensing. Two different ruthenium complexes were synthesized in the laboratory with an acceptable yield.

The tris(4,7-diphenyl-1,10-phenanthroline)ruthenium(II)hexafluorophosphate complex, which is a well known oxygen sensitive ruthenium complex, can be synthesized in the laboratory with a 95% yield. The tris(1,10-phenanthroline)ruthenium(II)hexafluorophosphate complex can be synthesized with a slightly lower yield of 82%.

The present invention provides an optical oxygen sensing device using a tris(4,7-diphenyl-1,10-phenanthroline)ruthenium(II)dichloride complex to measure the sensitivity to oxygen in the sensor film using fluorescence lifetime quenching parameter.

The present invention provides four different polymer matrices to prepare oxygen sensors; e.g., nafion, a perfluorinated polymer, was examined and was successful as an oxygen sensor. In addition, polystyrene and protonated polystyrene sulfonate polymer were also used. The oxygen sensor made using the heterogeneous polyacrylate polymer gives the threshold T_{C} value of 2.0, which does not change with either the method of application or the materials reconstituted.

One embodiment of the present invention includes an oxygen sensor using polyacrylate polymer was with the ruthenium concentration of 0.005 g of [Ru(Ph₂Phen)₃](Cl)₂ complex per 1.0 gram of polymer. The plasticizer dioctylphthalate was in a ratio of about 0.5 grams plasticizer per about 1.0 gram of polymer. Ethyl acetate was used as the solvent to dissolve the polymer and the ruthenium complex was dissolved in dichloromethane. The polymer concentration used for the polymer ticket lies between 10%-20%. The order of addition was ruthenium mixed with polymer followed by the addition of the plasticizer. After mixing all three components together, the solution was cured for minimum of 24 hours at 60° C. to produce the dried sensor material. This material is reconstituted when required to produce the solutions required for preparing the free standing polymer sensor.

Although the present invention and its advantages have been described in detail, it should be understood that various changes, substitutions and alterations can be made herein without departing from the spirit and scope of the invention as defined by the following claims.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

1. Y. Amao, I. Okura, “Optical oxygen sensing materials: chemisorption film of ruthenium(II)polypyridyl complexes attached to anionic polymer”, Sensors and Actuators B 88 (2003) 162.
2. K. Ertekin, S. Kocak. M; S. Ozre, S. Aycan, B. Cetinkaya, “Enhanced optical oxygen sensing using a newly synthesized ruthenium complex together with oxygen carriers”, Talanta 61 (2003) 573.
3. P. Pramatha, P. K. Dutta, “Development of dissolved oxygen sensor using tris(bipyridyl)ruthenium(II) complexes entrapped in highly siliceous zeolite”, Microporous and Mesoporus Materials 64 (2003) 109.
4. Z. Wang, A. R. McWilliamas, C. E. B. Evans, X. Lu, S. Chung, M. A. Winnik, I. Manners, “Covalent attachment of Ru(II)phenanthroline complexes to polythionylphosphazenes: The development and evaluation of single component polymeric oxygen sensors”, Advanced Functional Materials 12 (2002) 6.
5. P. Zhang, J. Guo, Y. Wang, W. Pang, “Incorporation of luminescent tris(bypyridine)ruthenium(II) complex in mesoporous silica spheres and their spectroscopic and oxygen sensing properties”, Materials Latters 53 (2002) 400.
6. T. Ishiji, M. Kaneko, “Photoluminescence of pyrenebutyric acid incorporated into silicone film as a technique in luminescent oxygen sensing”, Analyst. 120 (1995) 1633.
7. E. D. Lee, T. C. Werner, W. R. Seitz, “Luminesecence ratio indicators for oxygen”, Anal. Chem 59 (1987) 279.
8. A. Sharma, O, S. Wolfbeis, “The quenching of fluorescence of polycyclic aromatic hydrocarbons and rhodamine 6G by sulphur dioxide”, Spectrochemica Acta. 43A (1987) 1417
9. W. Xu, R. Schimidt, M. Whaley, J. N. Demas, B. A. Graff, E. K. Karikar, B. L. Framer, “Oxygen sensors based on luminescence quenching: Interactions of pyrene with the polymer support”, Anal. Chem. 67 (1995) 3172.
10. S. K. Lee, I. Ocra, “Photoluminescent determination of oxygen using metallopophyrin-polymer sensing systems”, Spectrochemica Acta Part A 54 (1998) 91.
11. M. Matsuguchi, K. Tamai, Y. Sakai, “SO₂ gas sensors using polymers with different amino groups”, Sensors and Actuators B. 77 (2001) 363.
12. J. N. Demas, B. A. DeGraff, W. Xu, “Modeling of luminescence quenching-based sensors: comparison of multisite and nonlinear gas solubility models”, Anal. Chem. 67 (1995) 1377.
13. A. Juris, V. Balzani, Ru(II)polypyridine complexes: Photophysics, photochemistry, electrochemistry and chemiluminescence” Coordination Chemistry Reviews, 84 (1988) 85-277.
14. R. B. Nair, B. M. Cullum, C. J. Murphy, “Optical properties of [Ru(phen)₂dppz]²⁺ as a function of nonaqueous environment”, Inorg. Chem. 36 (1997) 962.
15. A. S. Torres, D. J. Maloney, D. Tate, Y. Saad, F. M. MacDonnel, “Retention of optical activity during conversion of Λ-[Ru(1,10-phenanthroline)₃]²⁺ to Λ-[Ru(1,10-phenanthroline-5,6-dione)₃]²⁺ and Λ-[Ru(dipyrido[a:3,2-h:2′,3′-c-]-phenazine)₃]²⁺” Inorganic Chimica Acta 293 (1999) 37-43.
16. J. Yang, K. C. Gordan, “Light-emitting devices based on ruthenium(II)(4,7-diphenyl-1,10-phenanthroline)₃: Device response rate and efficiency by use of tris-(8-hydroxyquinoline) aluminum”, Journal of Applied Physics 94 (2003) 6391.
17. J. Liu, Q. Zhang, X. Shi, L. Ji, “Interaction of [Ru(dmp)₂(dppz)]²⁺ and [Ru(dmb)₂(dppz)]²⁺ with DNA: Effects of the Ancillary ligands on the DNA-binding behavior” Inorg. Chem. 40 (2001) 5045-5050.
18. J. Liu, B. Ye, H. Li, L. Ji, R. Li, J. Zhou, “Synthesis, characterization and DNA-binding properties of novel dipyridophenazine complex of ruthenium(II): [Ru(IP)₂(DPPZ)]²⁺”, J. Inorg. Biochemistry 73, 1999, 117-122.
19. S. J. Glen, B. M. Cullum, R. B. Nair, D. A. Nivens, C. J. Murphy, S. M. Angel, “lifetime based fiber optic water sensor using a luminescent complex in a lithium treated nafion membrane”, Analytica Chimica Acta. 488 (2001) 1.
20. E. Sabatani, H. D. Nikol, H. B. Gray, F. C. Anson, “Emission spectroscopy of Ru(bpy)₂dppz²⁺ in nafion. Probing the chemical environment in cast films”, J. Am. Chem. Soc. 118 (1996) 1158.
21. M. Bai, W. R. Seitz, “A fiber optic sensor for water in organic solvents based on polymer swelling”, Talanta. 41 (1994) 993.
22. B. Adhikari, S. Majumdar, “Polymers in sensor applications”, Progress in Polymer Science; General review written in English 29 (2004) 699.
23. http;//www.psrc.usm.edu/mauritz/nafion.html
24. J. S. Foos, P. G. Edelman, J. E. Flaherty, J. Berger, “Extended use planar sensor”, U.S. Pat. No. 5,387,329.
25. W. J. Bowyer, W. Xu, J. N. Demas, “Determining oxygen diffusion coefficient in polymer films by lifetimes of luminescent complexes measured in the frequency domain”, Anal. Chem., 2004, 76, 4374-4378.
26. Oxysense 101 Non-Invasive oxygen analyzer system, operation manual, 2001, pg 5.
27. B. P. Sullivan, D. J. Salmon, T. J. Meyer, “Mixed phosphine 2,2′-Bipyridine complexes of Ruthenium”, Inorganic Chem. 17 (1978) 3334.
28. M. Yamada, Y. Tanaka, Y. Yoshimoto, S. Kuroda, I. Shima, “Synthesis and properties of diamino substituted dipyrido[3,2-a:2′,3′-c]phenazine”, Bull. Chem. Soc. Jpn. 65 (1992) 1006.
29. A. S. Torres, D. J. Maloney, D. Tate, Y. Saad, F. M. MacDonnel, “Retention of optical activity during conversion of Λ-[Ru(1,10-phenanthroline)3]2+ to Λ-[Ru(1,10-phenanthroline-5,6-dione)3]2+ and Λ-[Ru(dipyrido[a:3,2-h:2′,3′-c-]-phenazine)3]2+”, Inorganic Chimica Acta 293 (1999) 37.
30. P. J. Glordano, C. R. Bock, M. S. Wrighton, “Excited state proton transfer of ruthenium(II) complexes of 4,7-dihydroxy-1,10-phenanthroline. Increased acidity in the excited state”, J. Am. Chem. Soc. 100:22 (1978) 6960.
31. R. J. Watts, G. A. Crosby, “Spectroscopic characterization of complexes of ruthenium and iridium(III) with 4,4′-diphenyl-2,2′-bipyridine and 4,7-diphenyl-1,10-phenanthroline”, J. Am. Chem. Soc. 93:13 (1971) 3184.
32. F. Shen, H. Xia, C. Zhang, D. Lin, X. Liu, “Spectral investigation for phosphorescent polymer light-emitting devices with doubly doped phosphorescent dyes”, Applied Physics Letters 84 (2004) 55.
33. M. N. Ackermann, L. V. Interrante, “Ruthenium(II) complexes of modified 1,10-phenanthrolines.1.synthesis and properties of complexes containing dipyridophenazines and a dicyanomethylene-substituted 1,10-phenanthroline”, Inorg. Chem. 23 (1984) 3904.
34. J. Fees, M. Ketterle, A. Klien, J. Fiedler, W. Kaim, “Electrochemical, spectroscopic and EPR study of transition metal complexes of dipyrido[3,2-a:2′,3′-c]phenazine”, J. Chem. Soc., Dalton Trans. (1999) 2595.

35. P. C. Alford, M. J. Cook, A. P. Lewis, G. S. G. McAuliffe, V. Skarda, A. J. Thomson, “Luminescent metal complexes.part 5: luminescence properties of ring substituted 1,10-phenanthroline tris-complexes of ruthenium(II)”, J. Chem. Soc. Perkin Trans. 11 (1985) 705.
36. D. M. Klassen, G. A. Crosby, “Spectroscopic studies of ruthenium(II) complexes. Assignment of the luminescence”, The J. Chem. Physics 48 (1968) 1853.
37. H. Xia, C. Zhang, X. Liu, S. Qiu, P. Lu, F. Shen, J. Zhang, Y. Ma, “Ruthenium(II) complex as phosphorescent Dopant for highly efficient red polymers light-emitting diodes”, J. Phys. Chem. B 108 (2004) 3185.
39. B. Adhikari, S. Majumdar, “Polymers in sensor applications”, Progress in Polymer Science; General review written in English 29 (2004) 699.
40. Y. Amao, I. Okura, “Optical oxygen sensing materials: chemisorption film of ruthenium(II)polypyridyl complexes attached to anionic polymer”, Sensors and Actuators B 88 (2003) 162.
41. P. Pramatha, P. K. Dutta, “Development of dissolved oxygen sensor using tris(bipyridyl)ruthenium(II) complexes entrapped in highly siliceous zeolite”, Microporous and Mesoporus Materials 64 (2003) 109.
42. M. Matsuguchi, K. Tamai, Y. Sakai, “SO2 gas sensors using polymers with different amino groups”, Sensors and Actuators B. 77 (2001) 363.
43. R. B. Nair, B. M. Cullum, C. J. Murphy, “Optical properties of [Ru(phen)2dppz]2+ as a function of nonaqueous environment”, Inorg. Chem. 36 (1997) 962.
44. K. Mitsubayashi, T. Kon, Y. Hashimoto, “Optical bio-sniffer for ethanol vapor using an oxygen-sensitive optical fiber”, Biosensors and Bioelectronics 19 (2003) 193.
45. J. S. Foos, P. G. Edelman, J. E. Flaherty, J. Berger, “Extended use planar sensor”, U.S. Pat. No. 5,387,329.
46. K. Ertekin, S. Kocak. M. S. Ozre, S. Aycan, B. Cetinkaya, “Enhanced optical oxygen sensing using a newly synthesized ruthenium complex together with oxygen carriers”, Talanta 61 (2003) 573.
47. Z. Wang, A. R. McWilliamas, C. E. B. Evans, X. Lu, S. Chung, M. A. Winnik, I. Manners, “Covalent attachment of Ru(II)phenanthroline complexes to polythionylphosphazenes: The development and evaluation of single component polymeric oxygen sensors”, Advanced Functional Materials 12 (2002) 6.
48. P. Zhang, J. Guo, Y. Wang, W. Pang, “Incorporation of luminescent tris(bypyridine)ruthenium(II) complex in mesoporous silica spheres and their spectroscopic and oxygen sensing properties”, Materials Latters 53 (2002) 400.
49. T. Ishiji, M. Kaneko, “Photoluminescence of pyrenebutyric acid incorporated into silicone film as a technique in luminescent oxygen sensing”, Analyst. 120 (1995) 1633.
50. W. Xu, R. Schimidt, M. Whaley, J. N. Demas, B. A. Graff, E. K. Karikar, B. L. Framer, “Oxygen sensors based on luminescence quenching: Interactions of pyrene with the polymer support”, Anal. Chem. 67 (1995) 3172.
51. S. K. Lee, I. Ocra, “Photoluminescent determination of oxygen using metallopophyrin-polymer sensing systems”, Spectrochemica Acta Part A 54 (1998) 91.
52. Oxysense 101 Non-Invasive oxygen analyzer system, operation manual, 2001.
53. D. P. Saini, M. Desuatel, “An exciting new non-invasive technology for measuring oxygen in seled packages the OxySense 101”, Presentes at Worldpack 2002, East Lansing, MI, USA.
54. A. Mills, A. Lepre, L. Wild, “Effect of plasticizer-polymer compatibility on the response characteristics of optical thin CO2 and O2 sensing films”, Analytical Chimica Acta 362 (1998) 193.
55. E. Sabatani, H. D. Nikol, H. B. Gray, F. C. Anson, “Emission spectroscopy of Ru(bpy)₂dppz²⁺ in nafion. Probing the chemical environment in cast films”, J. Am. Chem. Soc. 118 (1996) 1158.
56. S. J. Glen, B. M. Cullum, R. B. Nair, D. A. Nivens, C. J. Murphy, S. M. Angel, “lifetime based fiber optic water sensor using a luminescent complex in a lithium treated nafion membrane”, Analytica Chimica Acta. 488 (2001) 1.
57. Y. Amao, I. Okura, “Optical oxygen sensing materials: chemisorption film of ruthenium(II)polypyridyl complexes attached to anionic polymer”, Sensors and Actuators B 88 (2003) 162.
58. S. K. Lee, I. Ocra, “Photoluminescent determination of oxygen using metallopophyrin-polymer sensing systems”, Spectrochemica Acta Part A 54 (1998) 91.
59. M. Bai, W. R. Seitz, “A fiber optic sensor for water in organic solvents based on polymer swelling”, Talanta. 41 (1994) 993.
60. W. J. Bowyer, W. Xu, J. N. Demas, “Determining oxygen diffusion coefficient in polymer films by lifetimes of luminescent complexes measured in the frequency domain”, Anal. Chem., 2004, 76, 4374-4378.
61. J. S. Foos, P. G. Edelman, J. E. Flaherty, J. Berger, “Extended use planar sensor”, U.S. Pat. No. 5,387,329.
62. J. Yang, K. C. Gordan, “Light-emitting devices based on ruthenium(II)(4,7-diphenyl-1,10-phenanthroline)3: Device response rate and efficiency by use of tris-(8-hydroxyquinoline)aluminum”, Journal of Applied Physics 94 (2003) 6391.
63. Oxysense 101 Non-Invasive oxygen analyzer system, operation manual, 2001.
64. Z. Wang, A. R. McWilliamas, C. E. B. Evans, X. Lu, S. Chung, M. A. Winnik, I. Manners, “Covalent attachment of Ru(II)phenanthroline complexes to polythionylphosphazenes: The development and evaluation of single component polymeric oxygen sensors”, Advanced Functional Materials 12 (2002) 6.
65. K. Ertekin, S. Kocak. M. S. Ozre, S. Aycan, B. Cetinkaya, “Enhanced optical oxygen sensing using a newly synthesized ruthenium complex together with oxygen carriers”, Talanta 61 (2003) 573.
66. A. Mills, A. Lepre, L. Wild, “Effect of plasticizer-polymer compatibility on the response characteristics of optical thin CO2 and O2 sensing films”, Analytical Chimica Acta 362 (1998) 193.
67. K. Ertekin, S. Kocak. M. S. Ozre, S. Aycan, B. Cetinkaya, “Enhanced optical oxygen sensing using a newly synthesized ruthenium complex together with oxygen carriers”, Talanta 61 (2003) 573.
68. Y. Amao, I. Okura, “Optical oxygen sensing materials: chemisorption film of ruthenium(II)polypyridyl complexes attached to anionic polymer”, Sensors and Actuators B 88 (2003) 162.
69. P. Pramatha, P. K. Dutta, “Development of dissolved oxygen sensor using tris(bipyridyl)ruthenium(II) complexes entrapped in highly siliceous zeolite”, Microporous and Mesoporus Materials 64 (2003) 109.K.
70. Z. Wang, A. R. McWilliamas, C. E. B. Evans, X. Lu, S. Chung, M. A. Winnik, I. Manners, “Covalent attachment of Ru(II)phenanthroline complexes to polythionylphosphazenes: The development and evaluation of single component polymeric oxygen sensors”, Advanced Functional Materials 12 (2002) 6.
71. P. Zhang, J. Guo, Y. Wang, W. Pang, “Incorporation of luminescent tris(bypyridine)ruthenium(II) complex in mesoporous silica spheres and their spectroscopic and oxygen sensing properties”, Materials Latters 53 (2002) 400.
72. T. Ishiji, M. Kaneko, “Photoluminescence of pyrenebutyric acid incorporated into silicone film as a technique in luminescent oxygen sensing”, Analyst. 120 (1995) 1633.
73. E. D. Lee, T. C. Werner, W. R. Seitz, “Luminesecence ratio indicators for oxygen”, Anal. Chem 59 (1987) 279.
74. A. Sharma, O. S. Wolfbeis, “The quenching of fluorescence of polycyclic aromatic hydrocarbons and rhodamine 6G by sulphur dioxide”, Spectrochemica Acta. 43A (1987) 1417
75. W. Xu, R. Schimidt, M. Whaley, J. N. Demas, B. A. Graff, E. K. Karikar, B. L. Framer, “Oxygen sensors based on luminescence quenching: Interactions of pyrene with the polymer support”, Anal. Chem. 67 (1995) 3172.
76. S. K. Lee, I. Ocra, “Photoluminescent determination of oxygen using metallopophyrin-polymer sensing systems”, Spectrochemica Acta Part A 54 (1998) 91.

What is claimed is:

1. A ruthenium-based luminescence indicator composition comprising:
a tris-4,7-diphenyl-1,10-phenanthroline ruthenium(II) compound and one or more dioctylphthalate compounds dispersed within a gas permeable polyacrylate matrix, wherein the tris-4,7-diphenyl-1,10-phenanthroline ruthenium(II) compound has a fluorescence lifetime that is affected by exposure to one or more gases and fluorescence lifetime can be monitored.

2. A ruthenium-based luminescence indicator composition comprising:
a ruthenium-based luminescence compound having one or more optical properties dispersed within a gas permeable polymer matrix, wherein exposure to one or more diffusible agents modifies the one or more optical properties of the ruthenium-based luminescence compound.

3. The composition of claim 2, wherein the one or more optical properties of the ruthenium-based luminescence compound comprise a fluorescence lifetime.

4. The composition of claim 2, wherein the ruthenium-based luminescence compound comprises one or more ruthenium(II)polypyridyl complexes.

5. The composition of claim 2, wherein the ruthenium-based optical sensor comprises pyrene-butyric acid, perylene-dibutyrate, benzo-perylene, vinylbenzo-perylene, 2,2′-bipyridine, 1,10-phenanthroline, 4,7-diphenyl-(1,20-phenanthroline), 4,7-dimethyl-1,10-phenanthroline, 4,7-disulfonated-diphenyl-1,10-phenanthroline, 5-bromo-1,10-phenanthroline, 5-chloro-1,10-phenanthroline, 2-2′bi-2-thiazoline, 2,2′-bithiazole, (4,7-diphenyl-1,1-phenanthroline)₃ and ligand metal complexes of ruthenium(II), osmium(II), iridium(III), rhodium(III) and chromium(III) ions.

6. The composition of claim 2, wherein the ruthenium-based luminescence compound comprises tris-4,7-diphenyl-1,10-phenanthroline ruthenium(II) and the gas permeable polymer matrix comprises polyacrylate.

7. The composition of claim 2, further comprising a plasticizer comprising dioctyl phthalate, diphenyl isophthalate, p-toluene sulfonic acid monohydrate, phthalic acid benzyl n-butyl ester, diphenyl phthalate, p-styrene sulfonic acid, allylsulfonic acid sodium salt, vinylsulfonic acid sodium salt or combinations thereof.

8. The composition of claim 2, wherein the gas permeable polymer matrix is substantially free of leachable plasticizers.

9. The composition of claim 2, wherein the luminescent compound is contained within a gas permeable polymer matrix that is permeable to oxygen and relatively impermeable to water and non-gaseous analytes, wherein the gas permeable polymer matrix comprises polystyrene, protonated polystyrene, polyacrylate, nafion, polyalkanes, polymethacrylates, polynitriles, polyvinyls, polydienes, polyesters, polycarbonates, polysiloxanes, polyamides, polyacetates, polyimides, polyurethanes or derivatives and combinations thereof.

10. A food packaging membrane capable of detecting one or more analytes contacting the food packaging membrane comprising:
a diffusible polymer matrix membrane comprising a ruthenium-based luminescence compound dispersed within a diffusible polymer matrix, wherein the ruthenium-based luminescence compound has one or more optical properties and interacts with one or more analytes that modify the optical property of the ruthenium-based luminescence compound to provide information on the one or more analytes.

11. The device of claim 10, wherein the ruthenium-based luminescence compound is positioned on, about or within the food packaging membrane.

12. The device of claim 10, wherein the food packaging membrane comprises at least a portion of a sealable container.

13. An optical sensor system for determining analyte presence or concentration comprising:
an indicator capable of emitting an optical signal comprising a luminescence ruthenium compound having one or more analyte modifiable optical properties dispersed within a gas permeable polymer matrix, wherein exposure to one or more diffusible analytes modifies the one or more optical properties of the luminescence ruthenium compound; and
a transceiver positioned to detect one or more optical signals from the luminescence ruthenium compound.

14. The system of claim 13, wherein the transceiver emits one or more excitation signals between about 440 nm and 480 nm and detects the optical signal in the range of about 580 nm to about 640 nm.

15. The system of claim 13, further comprising a dioctylphthalate plasticizer, wherein the ruthenium-based luminescence compound comprises tris-4,7-diphenyl-1,10-phenanthroline ruthenium(II) and the gas permeable polymer matrix comprises polyacrylate.

16. The system of claim 13 further comprising an information display in communication with the transceiver to display the one or more optical signals from the luminescence ruthenium compound, wherein the one or more optical signals correlate to a concentration.

17. The system of claim 13, wherein the one or more optical properties of the ruthenium-based luminescence compound comprise a fluorescence lifetime.

18. The system of claim 13, further comprising a plasticizer comprising dioctyl phthalate, diphenyl isophthalate, p-toluene sulfonic acid monohydrate, phthalic acid benzyl n-butyl ester, diphenyl phthalate, p-styrene sulfonic acid, allylsulfonic acid sodium salt, vinylsulfonic acid sodium salt or combinations thereof.

19. A method of detecting exposure to one or more gases within a container comprising the steps of:
detecting one or more optical properties of a luminescent ruthenium compound dispersed in a gas permeable polymeric material, wherein the luminescent ruthenium compound has one or more optical properties that are modified by exposure to one or more gases; and
correlating the one or more optical properties of the luminescent ruthenium compound to exposure to one or more gases.

20. The method of claim 19, further comprising a gas concentration based on the correlated one or more optical properties of the luminescent ruthenium compound.

21. The method of claim 19, further comprising a dioctylphthalate plasticizer, wherein the ruthenium-based luminescence compound comprises tris-4,7-diphenyl-1,10-phenanthroline ruthenium(II) and the gas permeable polymer matrix comprises polyacrylate.

22. The method of claim 19, wherein the one or more optical properties of the ruthenium-based luminescence compound comprise a fluorescence lifetime.

23. A method of making a gas sensitive package sensor for detecting exposure to one or more gases comprising the steps of:
forming a ruthenium-based package sensor comprising a ruthenium-based luminescence compound dispersed in a gas permeable polymeric substrate, wherein the ruthenium-based luminescence compound comprises a gas modifiable optical property; and
affixing the ruthenium-based sensor in, on or about a package interior, wherein the ruthenium-based luminescence compound is in fluid communication with the package interior and the contents of the package.

24. The method of claim 23, further comprising a dioctylphthalate plasticizer, wherein the ruthenium-based luminescence compound comprises tris-4,7-diphenyl-1,10-phenanthroline ruthenium(II) and the gas permeable polymer matrix comprises polyacrylate.

25. The method of claim 23, wherein the modifiable optical property of the ruthenium-based luminescence compound comprise a fluorescence lifetime.
